(19) United States
(12) Patent Application Publication
(10) Pub. No.: US 2025/0350945 A1
(43) Pub. Date: Nov. 13, 2025

(54) AUTHENTICATED DEVICE USED TO UNLOCK ANOTHER DEVICE

(71) Applicant: Apple Inc., Cupertino, CA (US)

(72) Inventors: Lawrence Y. YANG, Bellevue, WA (US); John J. IAROCCI, Los Gatos, CA (US); Gary Ian BUTCHER, Los Gatos, CA (US); Kevin LYNCH, Woodside, CA (US)

(21) Appl. No.: 19/276,998

(22) Filed: Jul. 22, 2025

Related U.S. Application Data
(63) Continuation of application No. 17/479,974, filed on Sep. 20, 2021.
Application No. 17/479,974 is a continuation of application No. 16/422,736, filed on May 24, 2019, now Pat. No. 11,126,704.
Application No. 16/422,736 is a continuation of application No. 14/719,217, filed on May 21, 2015, now Pat. No. 10,339,293.
Application No. 14/719,217 is a continuation of application No. PCT/US15/25188, filed on Apr. 9, 2015.
(60) Provisional application No. 62/038,077, filed on Aug. 15, 2014.
(60) Provisional application No. 62/038,077, filed on Aug. 15, 2014.
(60) Provisional application No. 62/129,747, filed on Mar. 6, 2015.
(60) Provisional application No. 62/129,747, filed on Mar. 6, 2015.

(51) Int. Cl. H04W 12/08; G06F 21/35; H04M 1/67; H04M 1/72412; H04W 4/80; H04W 12/06; H04W 12/30; H04W 12/63; H04W 88/02

(52) U.S. Cl. CPC H04W 12/08; G06F 21/35; H04M 1/67; H04M 1/72412; H04W 4/80; H04W 12/06; H04W 12/30; H04W 12/63; H04W 88/02

(57) ABSTRACT

An electronic device that has a user-interface locked state and a user-interface unlocked state communicates with an external device using wireless communication to facilitate unlocking of the electronic device.

### CROSS-REFERENCE TO RELATED APPLICATIONS

This application is a continuation of U.S. patent application Ser. No. 17/479,974, titled “AUTHENTICATED DEVICE USED TO UNLOCK ANOTHER DEVICE,” filed Sep. 20, 2021, which is a continuation of U.S. patent application Ser. No. 16/422,736 (now U.S. Pat. No. 11,126,704), titled “AUTHENTICATED DEVICE USED TO UNLOCK ANOTHER DEVICE,” filed May 24, 2019, which is a continuation of U.S. patent application Ser. No. 14/719,217 (now U.S. Pat. No. 10,339,293), titled “AUTHENTICATED DEVICE USED TO UNLOCK ANOTHER DEVICE,” filed May 21, 2015, which claims the benefit of priority of U.S. Provisional Patent Application Ser. No. 62/038,077, titled “AUTHENTICATED DEVICE USED TO UNLOCK ANOTHER DEVICE,” filed Aug. 15, 2014; U.S. Provisional Patent Application Ser. No. 62/129,747, titled “AUTHENTICATED DEVICE USED TO UNLOCK ANOTHER DEVICE,” filed Mar. 6, 2015; and is a continuation of International Application PCT/US15/25188, titled “AUTHENTICATED DEVICE USED TO UNLOCK ANOTHER DEVICE,” filed Apr. 9, 2015. The content of each of these applications is hereby incorporated by reference in its entirety.

This application relates to U.S. Patent Application Ser. No. 62/035,348, titled “CONTINUITY,” filed Aug. 8, 2014; and U.S. Patent Application Ser. No. 62/006,043, titled “CONTINUITY,” filed May 30, 2014. The content of these applications is hereby incorporated by reference in its entirety.

### BACKGROUND

### 1. Field

The present disclosure relates generally to computer user interfaces, and more specifically to techniques for permitting a user to transition from use of one device to another, seamlessly.

### 2. Description of Related Art

Modern electronic devices may have multiple input mechanisms such as touchscreens, touchpads, and/or buttons. One problem associated with using these input mechanisms is the unintentional activation or deactivation of functions due to unintentional contact. To address this problem, some devices may be locked upon satisfaction of predefined lock conditions, such as after a predetermined time of idleness has elapsed, or upon manual locking by a user. When locked, a device may remain operational but ignore most, if not all, user input so as to reduce the likelihood of unintentional action. That is, the device, its input mechanisms, and/or applications running thereon may ignore certain classes of input when locked.

One class of input that a locked device may still respond to is attempts to unlock the device. These inputs may involve known unlocking procedures, such as pressing a predefined set of buttons (simultaneously or sequentially) or entering a code or password. These unlock procedures have drawbacks, however. The button combinations may be hard to perform. Creating, memorizing, and recalling passwords, codes, and the like can be burdensome. These drawbacks are further exacerbated when a user switches between uses of multiple devices that require unlocking, particularly when the devices are configured to auto-lock after some duration of idleness.

There is a need for more efficient, user-friendly procedures for unlocking such devices, input mechanisms, and/or applications.

### BRIEF SUMMARY

In some embodiments, a method of unlocking an electronic device using an authenticated, external device comprises: at the electronic device, where the electronic device has a user-interface locked state and a user-interface unlocked state: detecting, via wireless communication, an external device; receiving, from the external device, unlocking information for unlocking the electronic device; detecting, while in the locked state, user input; and in response to detecting the user input and the received unlocking information, unlocking the electronic device.

In some embodiments, a method of using an electronic device (that has been authenticated) to unlock an external device comprises: at an electronic device, where the electronic device has a user-interface locked state and a user-interface unlock state, and is in the user-interface unlocked state: detecting, via wireless communication, an external device, where the external device has a user-interface locked state and a user-interface unlocked state, and is in the user-interface locked state; and transmitting, to the external device, unlocking data, where the external device unlocks after the external device receives the unlocking information and detects user input.

In some embodiments, a method of configuring an electronic device to recognize that an external device is an authenticated external device that may be used to facilitate the (automatic) unlock of the electronic device comprises: at the electronic device, where the electronic device has a user-interface locked state and a user-interface unlocked state, the electronic device within wireless communication range of an external device: receiving at the electronic device, while in the user-interface locked state, user input representing a credential for unlocking the electronic device. In response to a determination that the credential is valid, unlocking the electronic device. After unlocking, displaying, on a screen of the electronic device, an identification of the external device; and prompting a user to designate whether the external device is authorized to unlock the electronic device if, in the future, the external device comes within wireless communication range of the electronic device while the electronic device is in the user-interface locked state.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch-sensitive display in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 6A illustrates exemplary devices for performing auto-unlock techniques.

FIG. 6B illustrates exemplary devices for performing auto-unlock techniques.

FIG. 6C illustrates exemplary devices for performing auto-unlock techniques.

FIG. 6D illustrates exemplary user interface(s) for unlocking an electronic device.

FIG. 6E illustrates exemplary user interface(s) for unlocking an electronic device.

FIG. 6F illustrates exemplary user interface(s) for unlocking an electronic device.

FIG. 7A illustrates exemplary user interface(s) for unlocking an electronic device.

FIG. 7B illustrates exemplary user interface(s) for unlocking an electronic device.

FIG. 7C illustrates exemplary user interface(s) for unlocking an electronic device.

FIG. 7D illustrates exemplary user interface(s) for unlocking an electronic device.

FIG. 7E illustrates exemplary user interface(s) for unlocking an electronic device.

FIG. 7F illustrates exemplary user interface(s) for unlocking an electronic device.

FIG. 8A illustrates exemplary user interface(s) for unlocking an electronic device.

FIG. 8B illustrates exemplary user interface(s) for unlocking an electronic device.

FIG. 8C illustrates exemplary user interface(s) for unlocking an electronic device.

FIG. 9A illustrates exemplary user interface(s) for unlocking an electronic device.

FIG. 9B illustrates exemplary user interface(s) for unlocking an electronic device.

FIG. 10A illustrates exemplary user interface(s) for unlocking an electronic device.

FIG. 10B illustrates exemplary user interface(s) for unlocking an electronic device.

FIG. 10C illustrates exemplary user interface(s) for unlocking an electronic device.

FIG. 10D illustrates exemplary user interface(s) for unlocking an electronic device.

FIG. 11A illustrates exemplary user interface(s) for unlocking an electronic device.

FIG. 11B illustrates exemplary user interface(s) for unlocking an electronic device.

FIG. 11C illustrates exemplary user interface(s) for unlocking an electronic device.

FIG. 11D illustrates exemplary user interface(s) for unlocking an electronic device.

FIG. 11E illustrates exemplary user interface(s) for unlocking an electronic device.

FIG. 12 is a flow diagram illustrating a process for unlocking an electronic device.

FIG. 13 is a flow diagram illustrating a process for unlocking an electronic device.

FIG. 14 is a flow diagram illustrating a process for unlocking an electronic device.

FIG. 15 is a functional block diagram of an electronic device in accordance with some embodiments.

FIG. 16 is a functional block diagram of an electronic device in accordance with some embodiments.

FIG. 17 is a functional block diagram of an electronic device in accordance with some embodiments.

FIG. 18 is a functional block diagram of an electronic device in accordance with some embodiments.

### DESCRIPTION OF EMBODIMENTS

The following description sets forth exemplary methods, parameters and the like. It should be recognized, however, that such description is not intended as a limitation on the scope of the present disclosure but is instead provided as a description of exemplary embodiments.

It is desirable for a device that is trusted by other electronic devices (e.g., an “authenticated” device) to able to facilitate the unlocking of certain other electronic devices. Consider the situation in which a user owns and switches between uses of multiple electronic devices frequently. Upon unlocking one electronic device (e.g., by providing a password), would be useful for nearby devices (that are within wireless communications range) to also unlock automatically, or at least require a reduced set of user input for unlocking. In this way, the user may transition between different devices quickly, without having to enter corresponding passwords on each device. Techniques for performing these functionalities-using an authenticated device to unlock other electronic devices—may be referred to as auto-unlocking techniques.

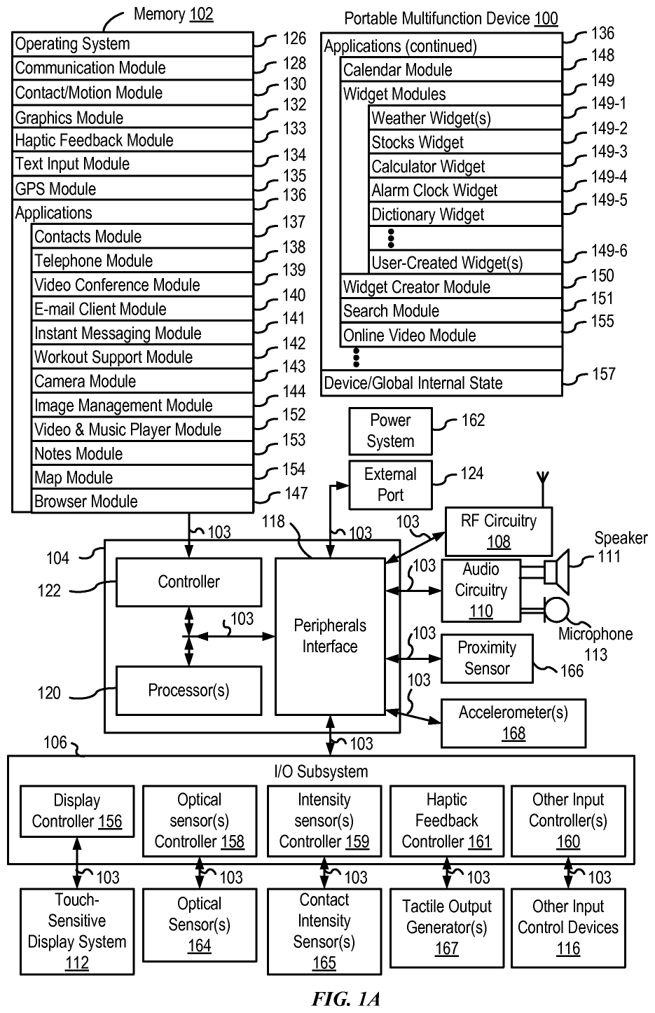

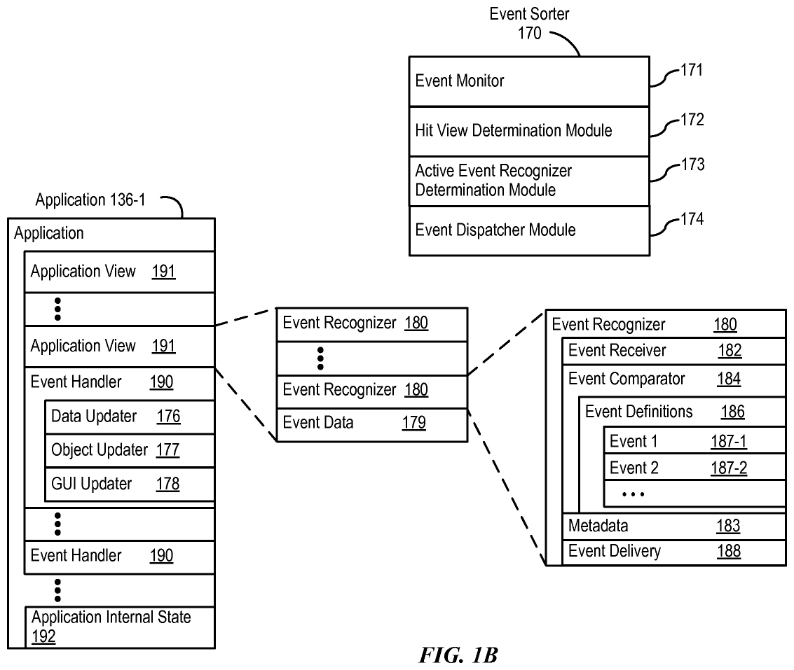

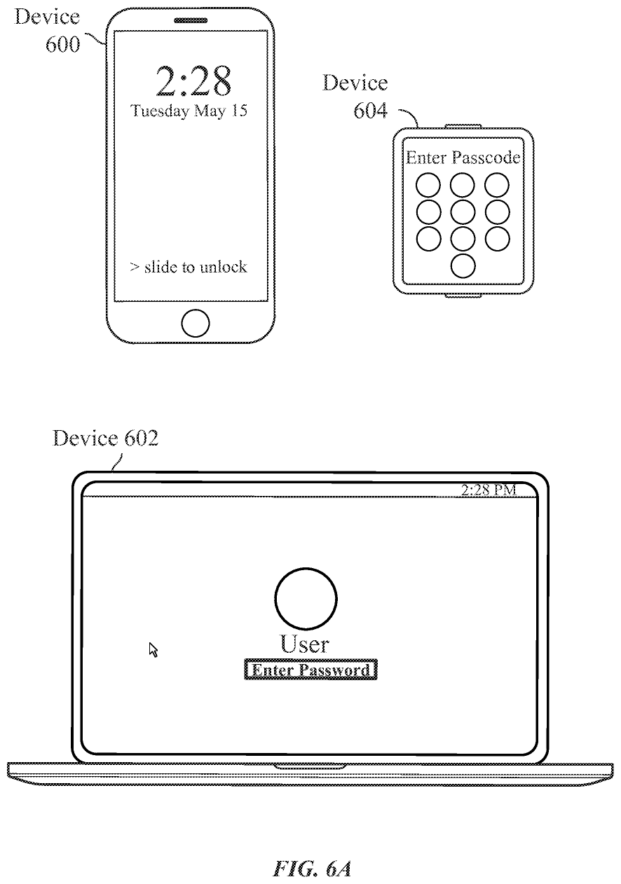

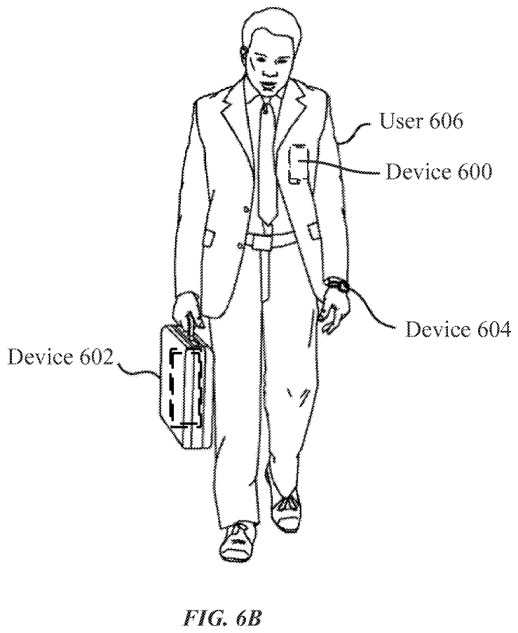

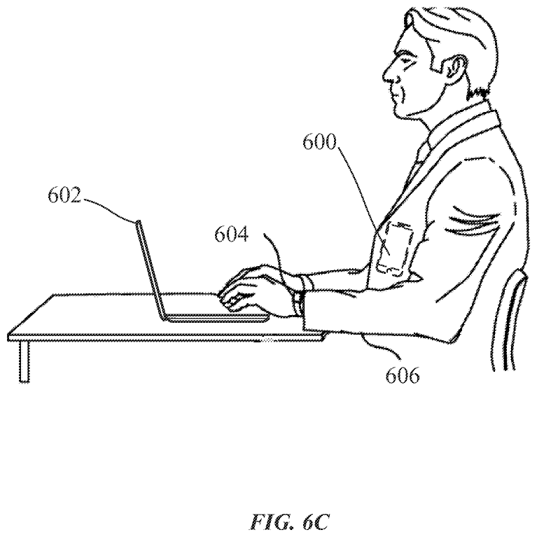

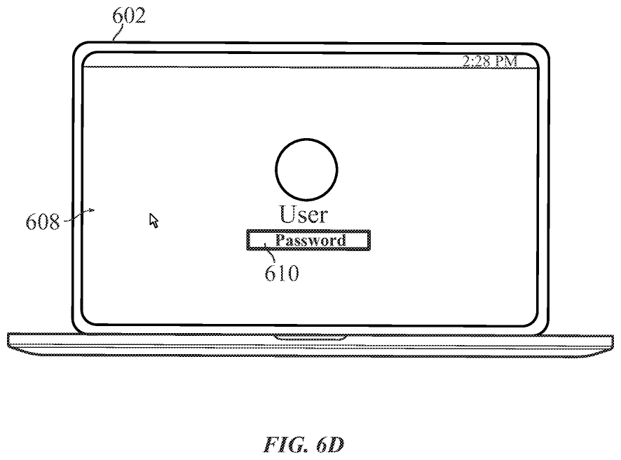

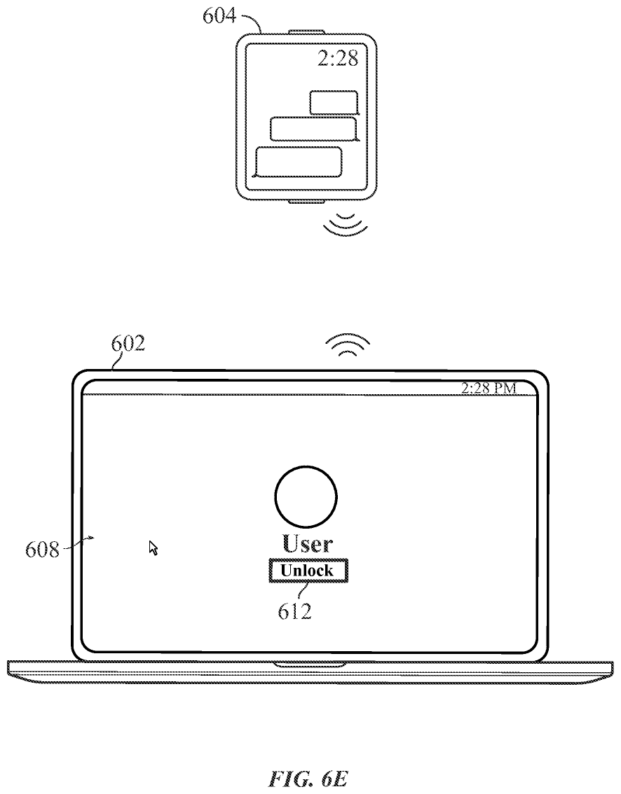

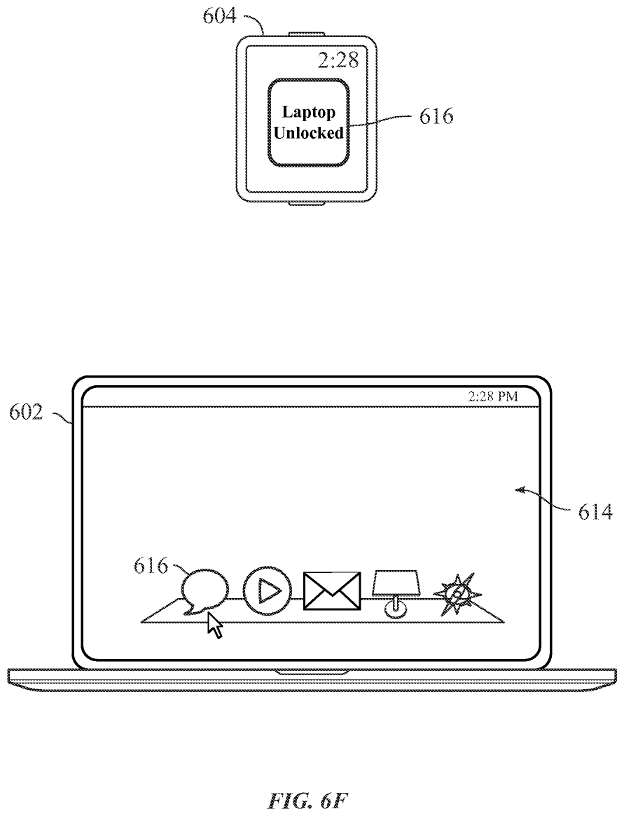

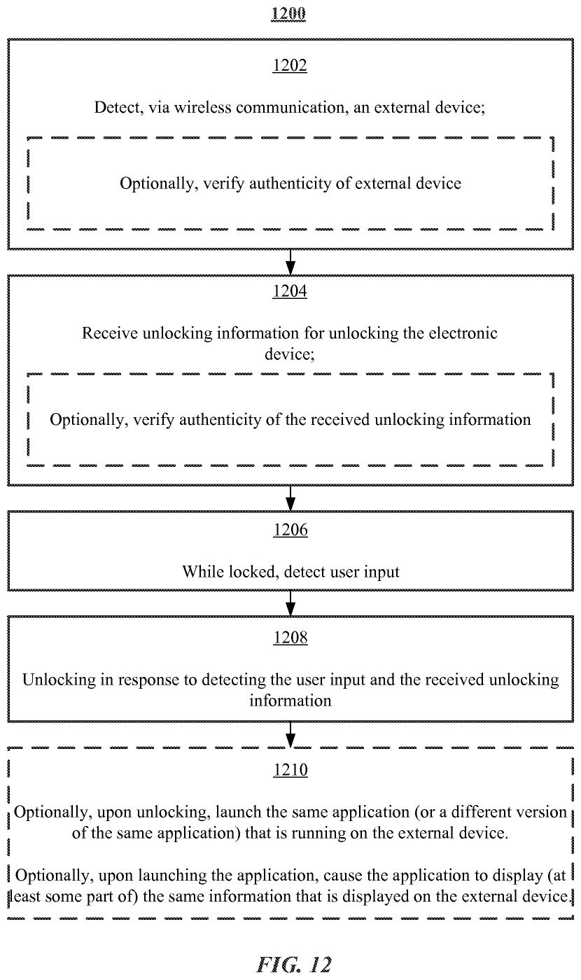

Below, FIGS. 1A-1B, 2, 3, 4A-4B, and 5A-5B provide a description of exemplary devices that may perform auto-unlocking techniques. FIGS. 6-11 illustrate exemplary user interfaces involved in the auto-unlocking of devices. The user interfaces in the figures are also used to illustrate the auto-unlocking processes described below, including the processes in FIGS. 12-14.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device may support a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch sensitive surface, or to a substitute (proxy) for the force or pressure of a contact on the touch sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits.

Memory 102 may include one or more computer readable storage mediums. The computer readable storage mediums may be tangible and non-transitory. Memory 102 may include high-speed random access memory and may also include non-volatile memory, such as one or more magnetic disk storage devices, flash memory devices, or other non-volatile solid-state memory devices. Memory controller 122 may control access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 may be implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 801.11n and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

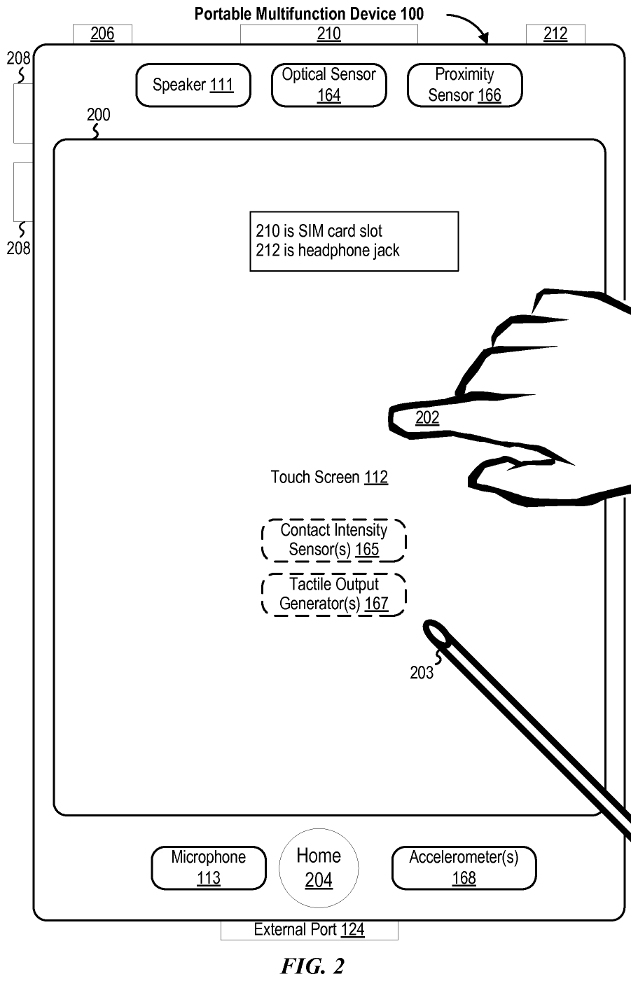

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button may disengage a lock of touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) may turn power to device 100 on or off. The user may be able to customize a functionality of one or more of the buttons. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web-pages or images) that are displayed on touch screen 112. In an exemplary embodiment, a point of contact between touch screen 112 and the user corresponds to a finger of the user.

Touch screen 112 may use LCD (liquid crystal display) technology, LPD (light emitting polymer display) technology, or LED (light emitting diode) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 may be analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch sensitive touchpads do not provide visual output.

A touch-sensitive display in some embodiments of touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 may have a video resolution in excess of 100 dpi. In some embodiments, the touch screen has a video resolution of approximately 160 dpi. The user may make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from touch screen 112 or an extension of the touch-sensitive surface formed by the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIG. 1A shows an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device, so that the touch screen display may be used as a viewfinder for still and/or video image acquisition. In some embodiments, an optical sensor is located on the front of the device so that the user's image may be obtained for video conferencing while the user views the other video conference participants on the touch screen display. In some embodiments, the position of optical sensor 164 can be changed by the user (e.g., by rotating the lens and the sensor in the device housing) so that a single optical sensor 164 may be used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 may also include one or more proximity sensors 166. FIG. 1A shows proximity sensor 166 coupled to peripherals interface 118. Alternately, proximity sensor 166 may be coupled to input controller 160 in I/O subsystem 106. Proximity sensor 166 may perform as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 may also include one or more accelerometers 168. FIG. 1A shows accelerometer 168 coupled to peripherals interface 118. Alternately, accelerometer 168 may be coupled to an input controller 160 in I/O subsystem 106. Accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

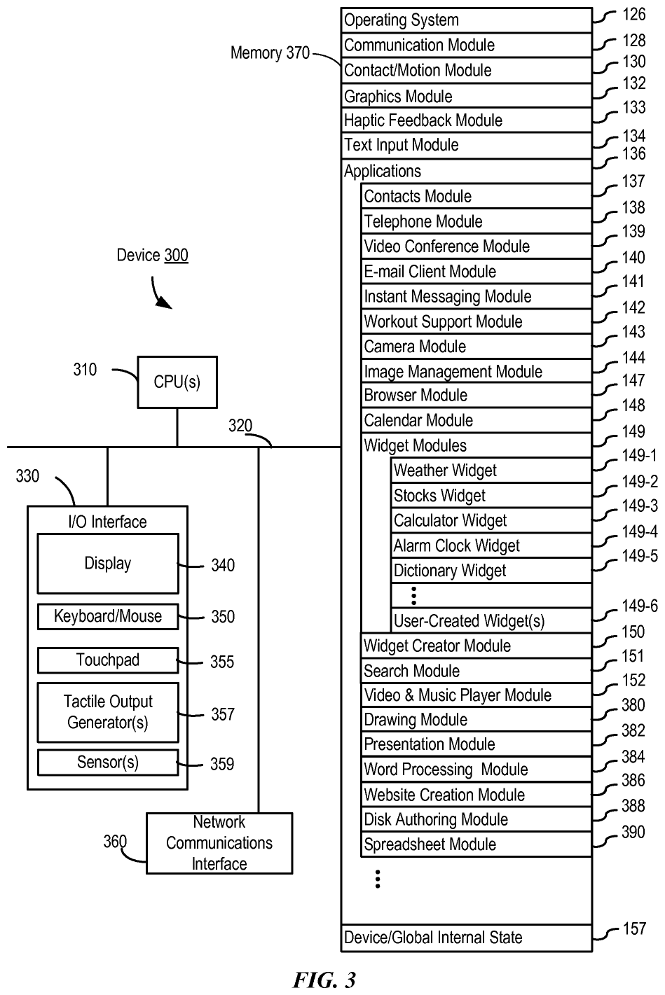

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod® (trademark of Apple Inc.) devices.

Contact/motion module 130 optionally detects contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which may be a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 may include the following modules (or sets of instructions), or a subset or superset thereof:
Contacts module 137 (sometimes called an address book or contact list);
Telephone module 138;
Video Conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which may include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 may be used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 may be used to enter a sequence of characters corresponding to a telephone number, access one or more telephone numbers in contacts module 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web-pages or portions thereof, as well as attachments and other files linked to web-pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 may be used by a user to create widgets (e.g., turning a user-specified portion of a web-page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to do lists, and the like in accordance with user instructions.

In conjunction with RF circuitry 108, touch screen 112, display controller 156, contact/motion module 130, graphics module 132, text input module 134, GPS module 135, and browser module 147, map module 154 may be used to receive, display, modify, and store maps and data associated with maps (e.g., driving directions; data on stores and other points of interest at or near a particular location; and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules may be combined or otherwise rearranged in various embodiments. For example, video player module may be combined with music player module into a single module (e.g., video and music player module 152, FIG. 1A). In some embodiments, memory 102 may store a subset of the modules and data structures identified above. Furthermore, memory 102 may store additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 may be reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 may utilize or call data updater 176, object updater 177 or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 may also include one or more physical buttons, such as “home” or menu button 204. As described previously, menu button 204 may be used to navigate to any application 136 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 may be stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules may be combined or otherwise rearranged in various embodiments. In some embodiments, memory 370 may store a subset of the modules and data structures identified above. Furthermore, memory 370 may store additional modules and data structures not described above.

Attention is now directed towards embodiments of user interfaces that may be implemented on, for example, portable multifunction device 100.

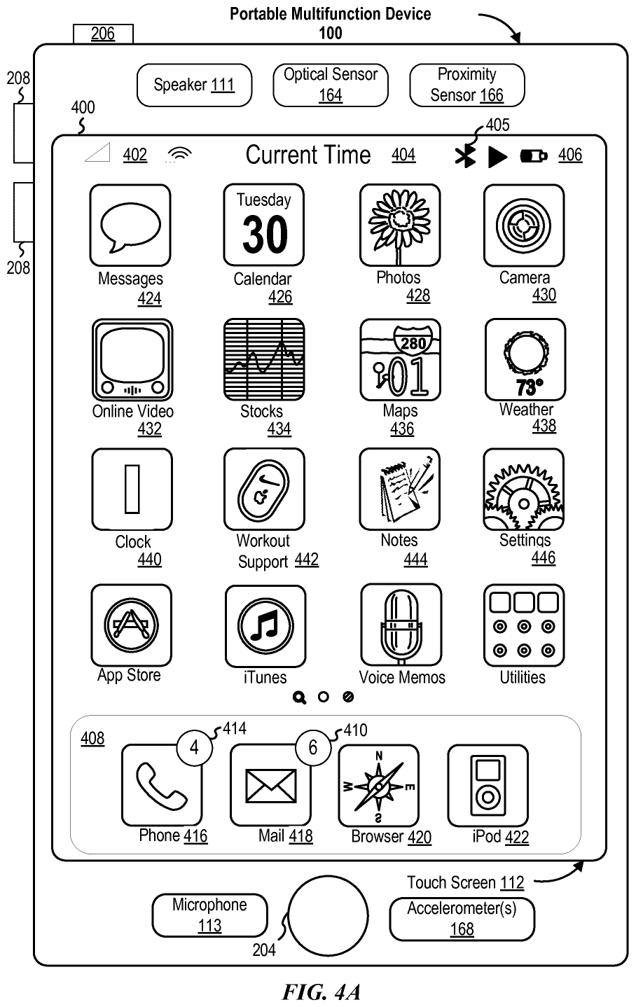

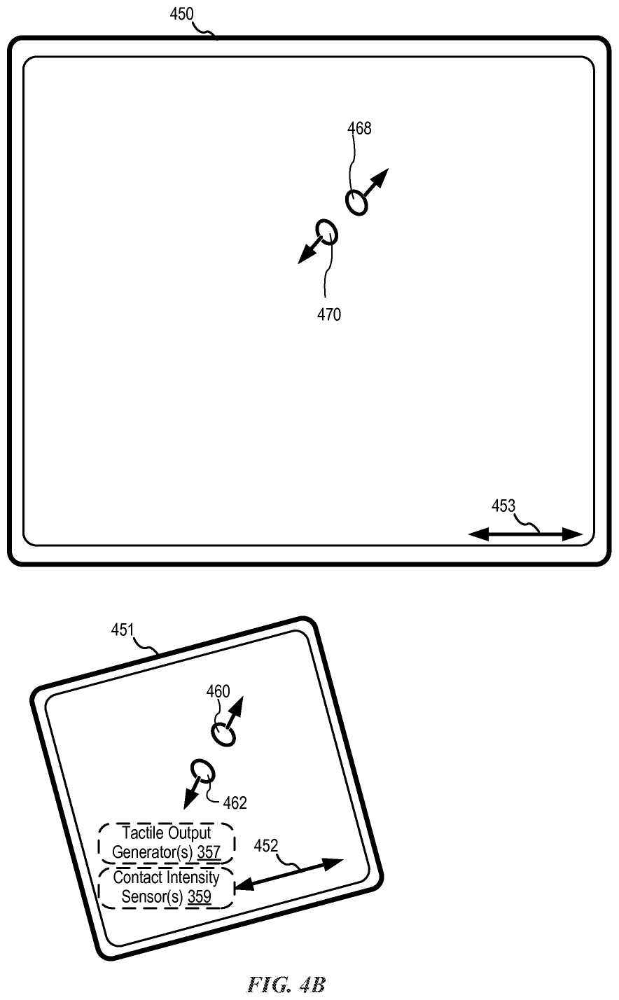

FIG. 4A illustrates an exemplary user interface for a menu of applications on portable multifunction device 100 in accordance with some embodiments. Similar user interfaces may be implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and

Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 357) for detecting intensity of contacts on touch-sensitive surface 451 and/or one or more tactile output generators 359 for generating tactile outputs for a user of device 300.

Although some of the examples which follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments the touch sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

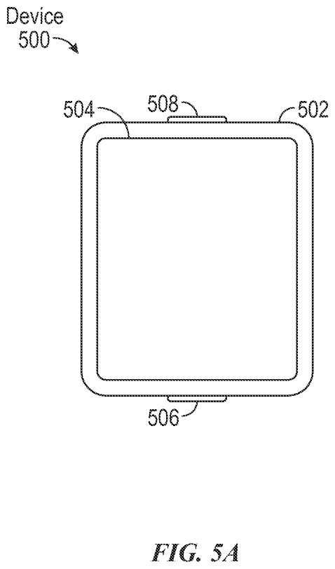

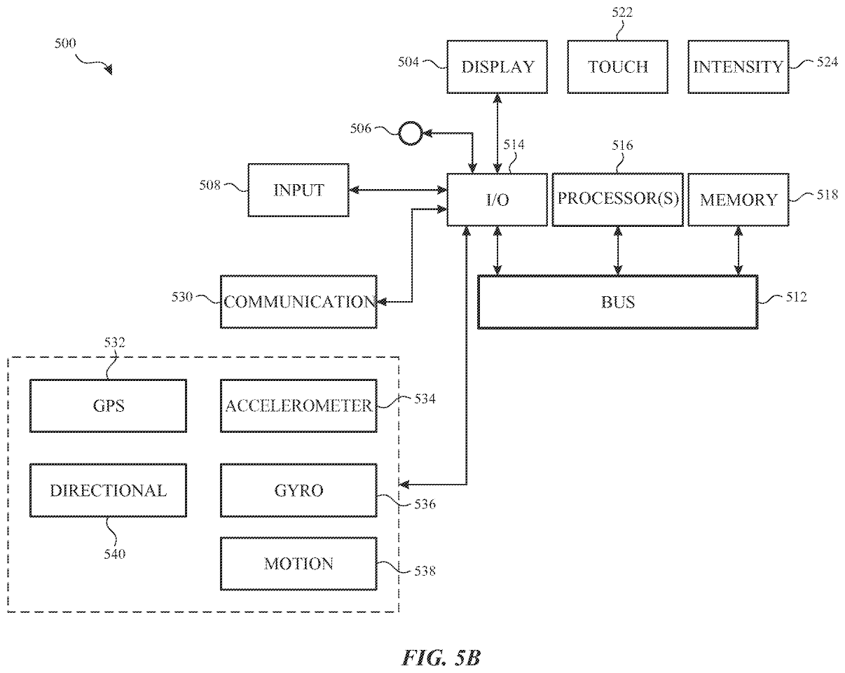

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) may have one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Techniques for detecting and processing touch intensity may be found, for example, in related applications: International Patent Application Serial No. PCT/US2013/040061, titled “Device, Method, and Graphical User Interface for Displaying User Interface Objects Corresponding to an Application,” filed May 8, 2013 and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms may permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, touch-intensity sensitive component 524. In addition, I/O section 514 can be connected with communication unit 530 for receiving application and operating system data, using Wi-Fi, Bluetooth, near field communication (NFC), cellular and/or other wireless communication techniques. Device 500 can include input mechanisms 506 and/or 508. Input mechanism 506 may be a rotatable input device or a depressible and rotatable input device, for example. Input mechanism 508 may be a button, in some examples.

Input mechanism 508 may be a microphone, in some examples. Personal electronic device 500 can include various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can be a non-transitory computer readable storage medium, for storing computer-executable instructions, which, when executed by one or more computer processors 516, for example, can cause the computer processors to perform the techniques described above, including processes 1200-1500 (FIGS. 12-15). The computer-executable instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. For purposes of this document, a “non-transitory computer readable storage medium” can be any medium that can tangibly contain or store computer-executable instructions for use by or in connection with the instruction execution system, apparatus, or device. The non-transitory computer readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that may be displayed on the display screen of device 100, 300, and/or 500 (FIGS. 1, 3, and 5). For example, an image (e.g., icon), a button, and text (e.g., hyperlink) may each constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch-screen display, a detected contact on the touch-screen acts as a “focus selector” so that when an input (e.g., a press input by the contact) is detected on the touch screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds may include a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In, some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface may receive a continuous swipe contact transitioning from a start location and reaching an end location, at which point the intensity of the contact increases. In this example, the characteristic intensity of the contact at the end location may be based on only a portion of the continuous swipe contact, and not the entire swipe contact (e.g., only the portion of the swipe contact at the end location). In some embodiments, a smoothing algorithm may be applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface may be characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments the contact-detection intensity threshold is zero. In some embodiments the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the term “open application” or “executing application” refers to a software application with retained state information (e.g., as part of device/global internal state 157 and/or application internal state 192). An open or executing application may be any one of the following types of applications:
an active application, which is currently displayed on a display screen of the device that the application is being used on;
a background application (or background processes) which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed to towards user interfaces (“UI”) and associated processes that may be implemented on a multifunction device with a display and a touch-sensitive surface, such as devices 100, 300, and/or 500 (FIGS. 1A, 3A, and/or 5A), to provide auto-unlocking functionalities.

### 1. User-Interface Lock and Unlock States

FIG. 6A illustrates exemplary electronic devices 600, 602, and 604. Device 600 may be device 100 (FIG. 1A) in some embodiments. In the illustrated example, device 600 is a phone. Device 602 may be device 300 (FIG. 3A) in some embodiments. In the illustrated example, device 602 is a laptop. Device 604 may be device 500 (FIG. 5A) in some embodiments. In the illustrated example, device 604 is a wearable electronic device.

Devices 600, 602, and 604 may each have a user-interface lock state and a user-interface unlock state. In the user-interface lock state (hereinafter the “lock state”), a device such as device 600, 602, or 604 is powered on and operational but ignores most, if not all, user input. That is, the device takes no action in response to user input and/or the device is prevented from performing a predefined set of operations in response to the user input. The predefined set of operations may include navigation between user interfaces and activation or deactivation of a predefined set of functions. The lock state may be used to prevent unintentional or unauthorized use of the device or activation or deactivation of functions on the device. A device may enter the lock state in response to user instruction to do so. A device may also enter the lock state after a period of idleness. The period may be specified by the user as a configuration setting. When the device is in the lock state, the device may be said to be locked. As shown, devices 600, 602, and 604 are locked.

In some embodiments, a device in the lock state may still respond to a limited set of user inputs, including input that corresponds to an attempt to transition the device to the user-interface unlock state or input that corresponds to powering the device off. In other words, the locked device responds to user input corresponding to attempts to transition the device to the user-interface unlock state or powering the device off, but does not respond to user input corresponding to attempts to navigate between user interfaces. Also, even if the device ignores a user input, the device may still provide sensory feedback (such as visual, audio, or vibration feedback) to the user upon detection of the input to indicate that the input will be ignored.

In the user-interface unlock state (hereinafter the “unlock state”), the device is in its normal operating state, detecting and responding to user input corresponding to interaction with the user interface. A device that is in the unlock state may be said to be unlocked. An unlocked device detects and responds to user input for navigating between user interfaces, entry of data and activation or deactivation of functions, and so forth. In embodiments where the device includes a touch-sensitive input mechanism, the unlocked device detects and responds to contact corresponding to navigation between user interfaces, entry of data and activation or deactivation of functions through the touch-sensitive input mechanism. In embodiments where the device includes a rotatable input mechanism, the unlocked device detects and responds to rotations and/or depressions corresponding to navigation between user interfaces, entry of data and activation or deactivation of functions through the rotatable input mechanism.

FIG. 6B illustrates user 606 who uses multiple electronic devices including devices 600, 602, and 604. Each of these devices may be locked. To use a particular device, user 606 may have to first unlock the device. As discussed above, this process may become burdensome, particularly if the devices are configured to automatically lock after some period of idleness.

FIG. 6C illustrates an exemplary situation in which the use of an authenticated device to unlock other electronic devices may be desirable. As shown, user 606 is readying to use device 602, a laptop. Device 602 may be configured to power-up into a locked state. User 606, however, may have been interacting with devices 600 or 604, meaning that devices 600 and/or 604 may still be unlocked. Devices 600 and 604 are also in physical proximity (e.g., within wireless communication range) of device 602. In this situation, it would be helpful for either device 600 or 604 to provide device 602 with credentials, such that device 602 may require minimal or no additional user input to unlock, thereby permitting user 606 to begin productive work on the device.

Attention is now directed to techniques for unlocking device 602 using unlocked device(s) 600 and 604, with reference to FIGS. 6D-6F. FIG. 6D depicts device 602 displaying user interface lock screen 608 indicating that the device is locked. In this state, device 602 accepts password entries in password input field 610 to unlock the device. It would be helpful for user 606 to be able to gain access to device 602 without having to manually enter a password, however. As shown in FIG. 6E, external device 604 may be within communications range of device 602. Device 602 may detect the presence of device 604 via a wireless communication protocol. Low-powered wireless communications may be particularly suited for this purpose. Examples of suitable wireless communications include Bluetooth® and Bluetooth Low Energy (BTLE). Similarly, devices 604 may detect nearby device 602.

As shown, external device 604 is in its unlocked state (e.g., normal operating mode), possibly due to recent usage by user 606 (FIG. 6C). Upon detection, device 604 may transmit, to device 602, information for facilitating the unlocking of device 602, such as user credentials. Assuming that device 602 trusts device 604, device 602 may use the received credentials information to facilitate its unlocking process.

In some embodiments, device 602 may unlock upon receiving the credentials information and, additionally, detecting a user input. The user input may be a mouse input such as a mouse movement or a mouse click. The user input may be a touch input such as a tap or a swipe. The user input may be a depression of a mechanical or capacitive input mechanism. In the illustrated example, upon receiving unlocking information from device 604, device 602 replaces password input field 610 (FIG. 6D) with affordance 612, which when selected (e.g., clicked), unlocks device 602. Note that, in embodiments requiring the detection of user input before unlocking, mere placement of devices (e.g., 604 and 602) into physical proximity, without more, should not be considered a detected user input.

In some embodiments, upon receiving credentials information from device 604, device 602 may automatically unlock without requiring further user input. In some embodiments, upon receiving credentials information from device 604, device 602 may unlock after detecting a valid biometric reading from a biometric input device. In these embodiments, the additional biometric reading may be used to form a two-factor authentication process.

FIG. 6F illustrates device 602 in the unlocked state. In this state, device 602 may display desktop screen 614 having affordances for launching various application programs (e.g., icon 616 for launching a messaging application). Optionally, device 604 may display visual indicator 616 and/or haptic feedback indicating that device 604 has effected the unlocking of device 602.

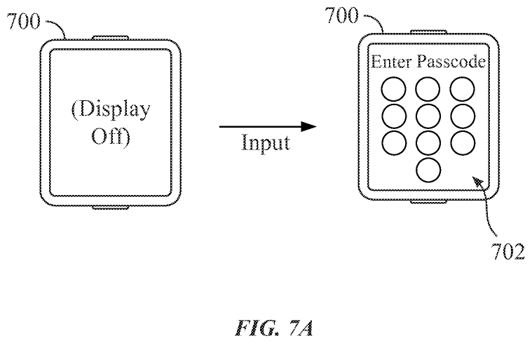

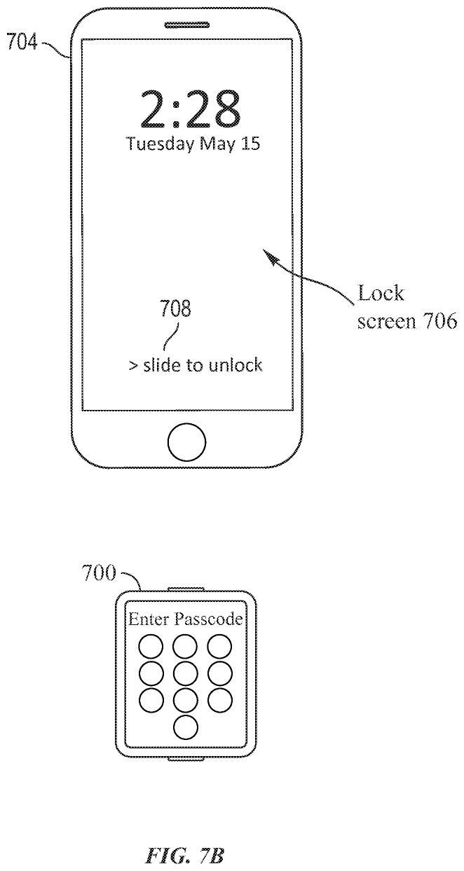

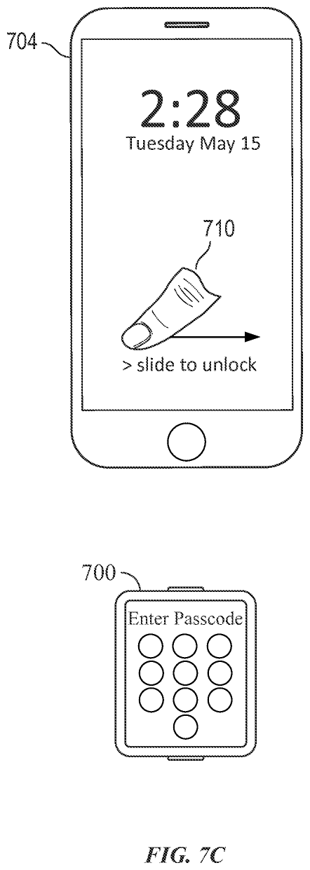

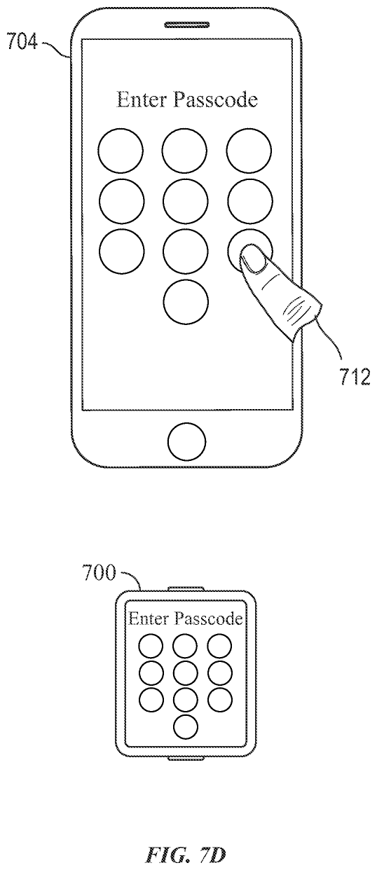

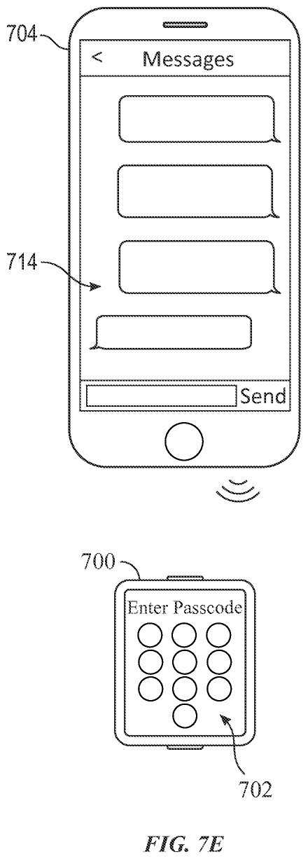

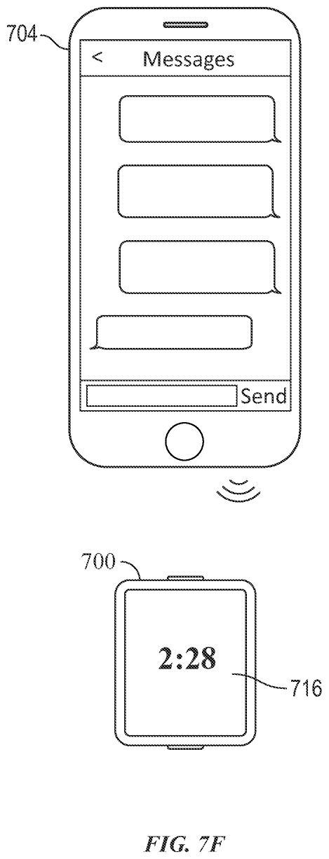

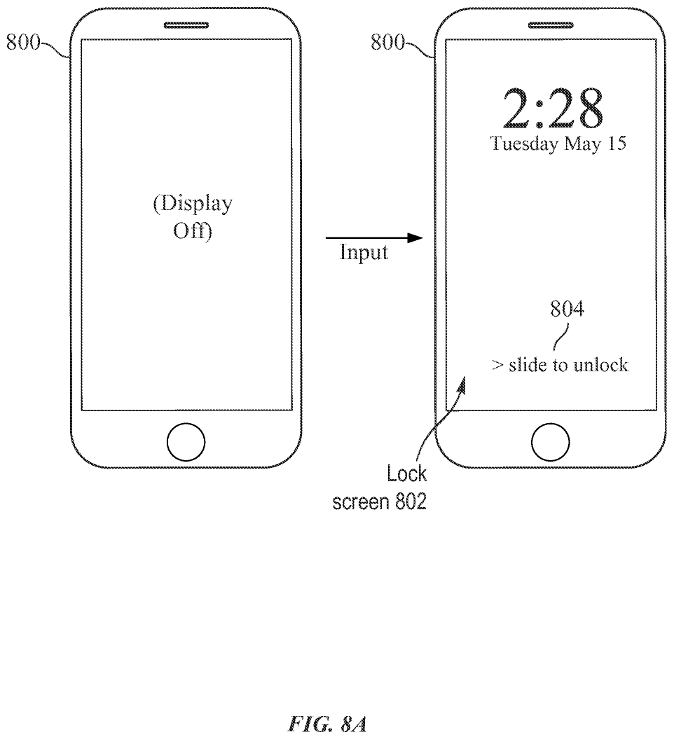

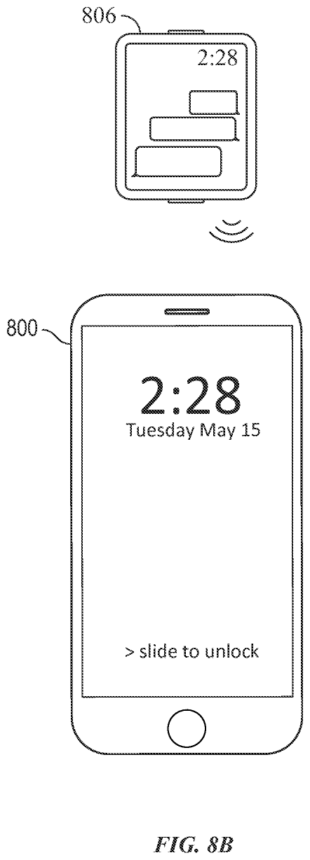

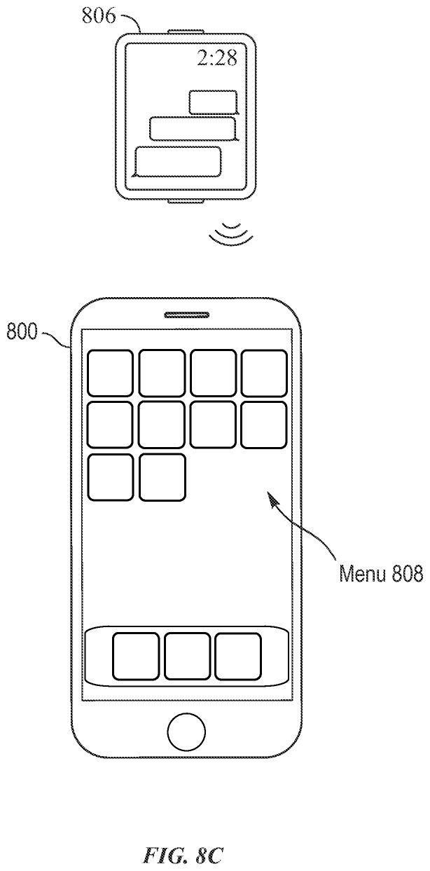

It is noted that although FIGS. 6D-6F illustrate the unlocking of device 602 with external device 604, the described techniques may be extended to cover other devices, such as devices 100, 300, 500. (FIGS. 1A, 3A, and 5A). That is to say, permutations of various electronic devices acting as lock and key are possible. For example, in some embodiments, device 100 (FIG. 1A) may act as an authenticated device for unlocking device 500 (FIG. 5A), as discussed below with reference to FIGS. 7A-7E. For example, in some embodiments, device 500 (FIG. 5A) may act as an authenticated device for unlocking device 100 (FIG. 1A), as discussed below with reference to FIGS. 8A-8C. For brevity, other permutations, while possible, are not explicitly discussed here.

Attention is now directed to additional techniques for using an authenticated device to unlock another electronic device, with reference to FIGS. 7A-7E. FIG. 7A depicts exemplary device 700, which may be device 500 (FIG. 5A) in some embodiments. Device 700 may have a display screen that turns off under some circumstances. For example, its display screen may turn off after a predetermined duration of idleness. The display screen of device 700 may turn on again in response to movement and/or user input. When the display screen of device 700 turns on, it may display lock screen 702 indicating that device 700 is locked. Lock screen 702 may prompt the user for a password for unlocking the device.

FIG. 7B depicts the presence of external device 704 within wireless communications range of device 700. Device 704 may be device 100 (FIG. 1A) in some embodiments. External device 704 may also be in the locked state, as shown by lock screen 706. Lock screen 706 may have instruction 708 indicating how device 704 may be unlocked. As device 704 is itself locked, device 700 does not respond by automatically unlocking.

FIG. 7C depicts user input 710 representing a user's attempt to unlock device 704. As shown, device 700 remains in its locked state while attempts are made to unlock device 704. FIG. 7D depicts further user input 712 representing the user's continued attempt to unlock device 704. Device 700 continues to remain in its locked state.

Turning to FIG. 7E, upon receiving a valid passcode via user input 712 (FIG. 7D), device 704 unlocks into its normal operating state. As shown, device 704 is executing active application 714. Application 714 may be a messaging application, such as Messages by Apple Inc. of Cupertino, California. After unlocking, device 704 also may transmit information to device 700, including information that facilitates the automatic unlocking of device 700.

In the example illustrated in FIG. 7F, upon receiving this information, device 700 automatically unlocks without requiring further user input, and displays clock screen 716. In some embodiments, device 700 may unlock upon receiving the credentials information and detecting a user input. The user input may be a movement of device 700. The user input may be a touch input such as a tap or a swipe. The user input may be a depression of a mechanical or capacitive input mechanism.

Attention is now directed to additional techniques for using an authenticated device to unlocking another electronic device, with reference to FIGS. 8A-8C. FIG. 8A depicts exemplary device 800, which may be device 100 (FIG. 1A) in some embodiments. Device 800 may have a display screen that turns off under some circumstances. For example, its display screen may turn off after a period of idleness. The display screen of device 800 may turn on again in response to movement of and/or user input. When the display screen of device 800 turns on, it may display lock screen 802 indicating that device 800 is locked. Lock screen 802 may have instruction 804 indicating how to unlock device 800.

FIG. 8B depicts the presence of external device 806 within wireless communications range of device 800. Device 806 may be device 500 (FIG. 5A) in some embodiments. Device 806 may have been recently used by the user (e.g., within the last 5-20 seconds), and therefore may be unlocked. Device 806 may transmit information to device 800 that facilitates the automatic unlocking of device 800. As shown in FIG. 8C, upon receiving this information, device 800 may automatically unlock without requiring further user input, thereby replacing lock screen 802 (FIG. 8B) with menu 808 having various application icons. In some embodiments, device 800 may require some user input (e.g., a substantially horizontal swipe) before unlocking.

### 2. Continuity of Application States Across Devices

As a user switches between uses of different devices, in addition to having devices auto-unlock, it would be helpful for the user to be able to transition content that is being displayed on one device onto another. Co-pending U.S. Provisional Application No. 62/035,348, titled “CONTINUITY,” filed Aug. 8, 2014, and incorporated herein in its entirety, describes the continuity of applications across multiple electronic devices, in that a user may work in one application on one device, and transition the work onto a nearby device that is within wireless communication range.

Aspects of continuity may be incorporated into the above-described user interfaces for using an authenticated device to unlock other devices. For example, as a target device auto-unlocks, it may be desirable for the target device to also launch the same application that is executing on the authenticated external device. It also may be desirable for the application, upon launching, to have the same application state (e.g., display the same information that is displayed on the authenticated external device).

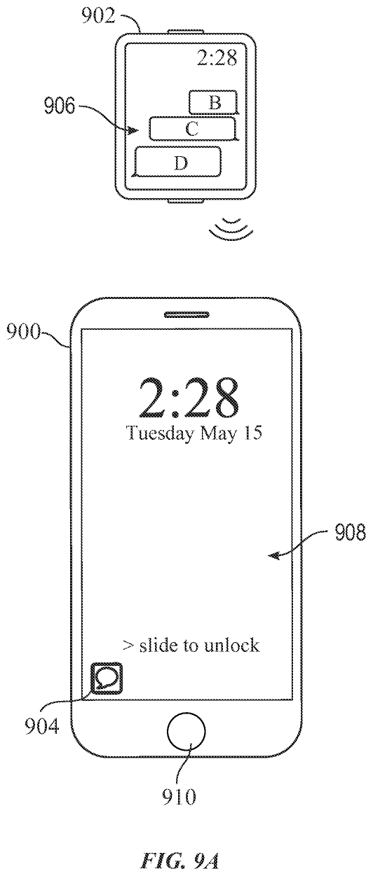

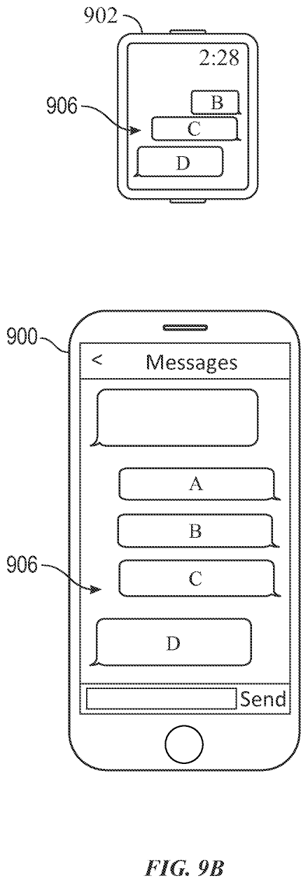

These features are described with reference to FIGS. 9A-9B. As shown in FIG. 9A, device 900 (which may be device 100 of FIG. 1A in some embodiments) and device 902 (which may be device 500 of FIG. 5A in some embodiments) are within wireless communications range. As shown, device 900 is locked and device 902 is unlocked. Device 902 may be displaying message transcript 906 via an active messaging application. Device 902 may transmit information to device 900 to facilitate the unlocking of device 900. In addition to user credentials, the information may include an identification of the application that is active on device 902 (e.g., the messaging application) and/or application state information (e.g., message transcript 906).

Device 900 may be configured to require a password before unlocking. However, having received unlocking information from device 902, device 900 may unlock without requiring the entry of additional password information. The additionally received application and/or application state information permits device 900 to further provide continuity functions after unlocking.

In the illustrated embodiment, in response to the transmitted information, device 900 may display affordance 904 indicating that a corresponding (messaging) application will be launched upon unlocking device 900. Also, affordance 904 may have a visual indication identifying the application (e.g., messaging) that will be launched when device 900 unlocks. As depicted in FIG. 9B, upon unlocking, device 900 may launch corresponding messaging application and display the same message transcript 906 being displayed on device 902. The amount of message transcript 906 displayed on devices 900 and 902 may vary depending on the form factors (e.g., display screen size and resolution) of the devices

In some embodiments (not illustrated), in place of affordance 904, device 900 may display an instruction on lock screen 908 indicating that the messaging application will be launched if the user proceeds to unlock device 900. For example, device 900 may display the instruction: “Slide to open Messages”. In some embodiments (not illustrated), responsive to the transmitted information, device 900 may permit unlocking via a single push of its mechanical input mechanism 910, and launch the corresponding application (e.g., Messages) upon unlocking. In some embodiments (not illustrated), responsive to the information transmitted from device 902, device 900 may simply unlock and launch the corresponding application without requiring further user input.

In some embodiments, device 900 may permit a user to unlock the device without necessarily invoking continuity functionality. Whether device 900 invokes continuity functionality may depend on the user input used to unlock device 900. For example, device 900 may launch a corresponding application if the user taps affordance 904, and yet refrain from launching the application if the user taps mechanical input mechanism 910 to unlock. Instead, when the user taps button 910, device 900 may unlock to display the most recently used application on device 900.

### 3. Authenticated Devices

Although it is useful for electronic devices to unlock one another in various situations, for privacy reasons, caution may be required in controlling which electronic devices are able to be able to facilitate the auto-unlocking of other devices. To put another way, it may be necessary to determine which electronic devices are to be authenticated for purposes of auto-unlocking functionality. Attention is now directed to user interfaces for authenticating devices for purposes of auto-unlocking devices such as devices 100, 300, and 500 (FIGS. 1A, 3A, and 5A).

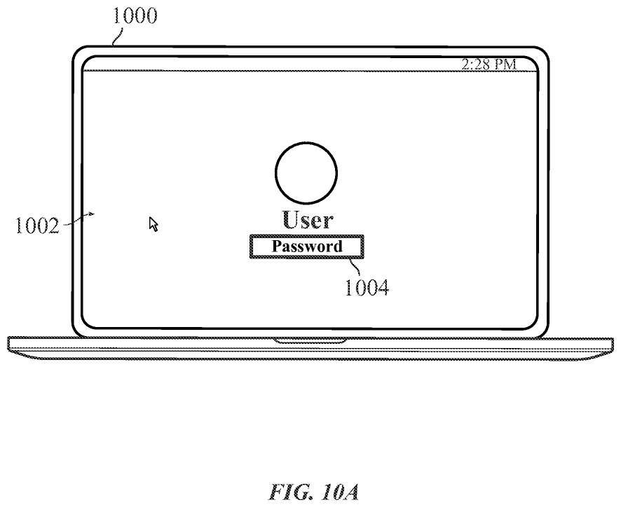

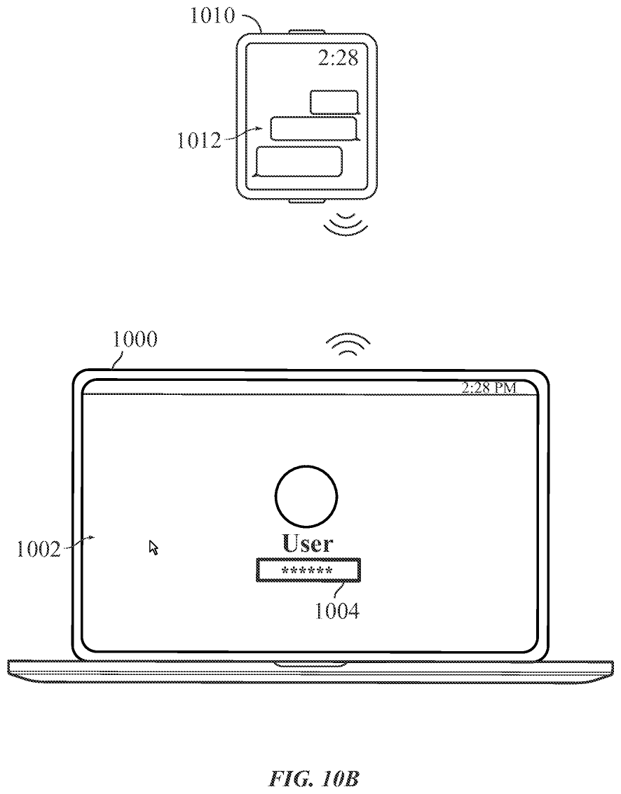

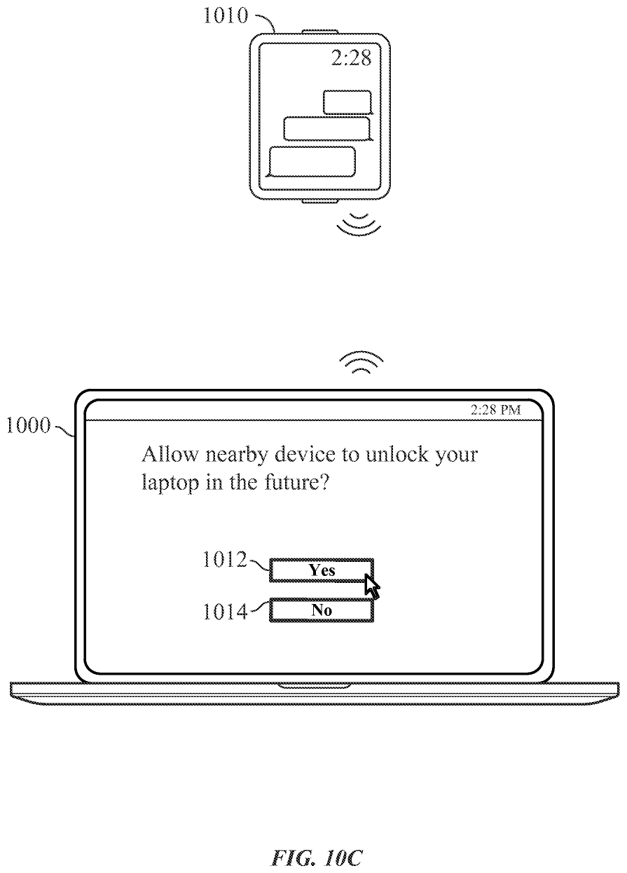

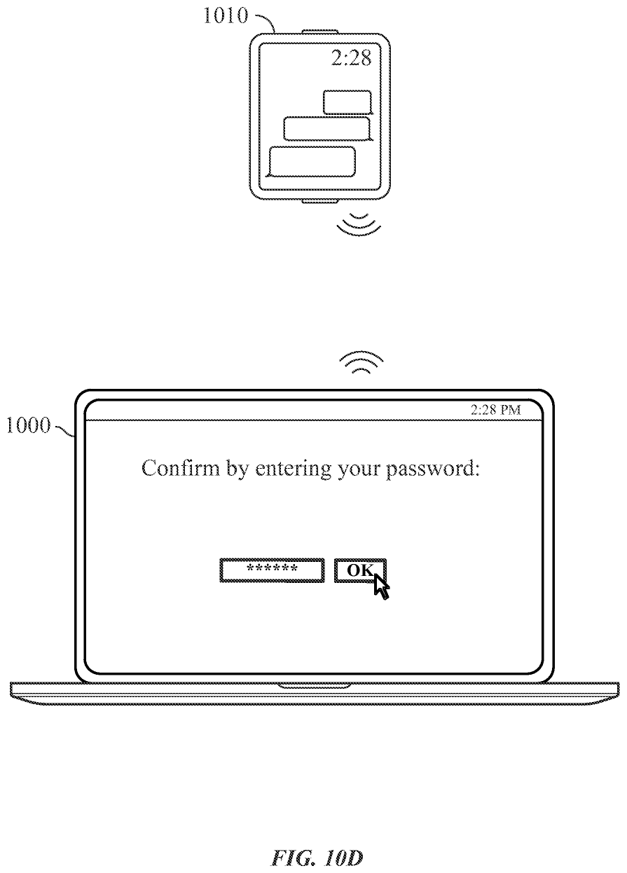

In some embodiments, a device may prompt the user as to whether a nearby external device should become authenticated, meaning whether the external device should become able to unlock the (prompting) device. This aspect is described with reference to FIGS. 10A-10D. FIG. 10A depicts device 1000, which may be device 300 (FIG. 3A) in some embodiments. Device 1000 may display lock screen 1002 indicating that it is locked. Lock screen 1002 may include password input field 1004 for unlocking device 1000.

FIG. 10B depicts the presence of external device 1010 within wireless communication range of device 1000. External device 1010 may be any one of devices 100, 300, or 500 (FIGS. 1A, 3A, 5A). In the illustrated embodiment, external device 1010 is device 500 (FIG. 5A). External device 1010 is shown in the unlocked state, actively executing a messaging application to display message transcript 1012. Device 1000 and external device 1010 may detect one another over wireless communication. External device 1010 may transmit information to device 1000 for facilitating the unlocking of device 1000.

In some embodiments, device 1000 may decline to unlock automatically based on the received information, because it has not been configured to trust device 1010. Restated, from the perspective of device 1000, device 1010 is not an authenticated device. As such, device 1000 may continue to display lock screen 1002. However, a user may manually unlock device 1000 while external device 1010 is still in-range. For example, the user may enter a valid password into password input field 1004 to unlock device 1002, as shown in FIG. 10B.

Turning to FIG. 10C, when the user manually unlocks device 1000 in the presence of unlocked external device 1010, device 1000 may prompt the user to indicate whether device 1000 should become an authenticated device. That is, device 1000 may ask whether external device 1010 should be permitted to auto-unlock device 1000, in the future, when external device 1010 comes into communications range again. The prompt may include an identification of external device 1010 by its make/model and/or its device name.

If the user responds in the affirmative (e.g., by selecting affordance 1012), device 1000 may register external device 1010 as an authenticated device, meaning that external device 1010 becomes an authenticated device for purposes of auto-unlocking device 1000. Restated, device 1010 is authorized to unlock device 1000 if, in the future, external device 1010 comes within wireless communication range of device 1000, and external device 1010 is unlocked while device 1000 is locked.

Additionally, in some embodiments, device 1000 may prompt the user to confirm the authentication of device 1002 by re-entering the user's password (for unlocking device 1000) on device 1000, as shown in FIG. 10D. In this way, device 1002 becomes able to auto-unlock device 1000 in the future.

If the user responds in the negative (e.g., by selecting affordance 1014), device 1000 may remember external device 1010 as a non-authenticated device. Accordingly, device 1000 may refrain from automatically prompting the user about authenticating external device 1010, should the two devices come into wireless communication again in the future. Device 1000 may also refrain from automatically unlocking when device 1010 comes within wireless communication range again in the future.

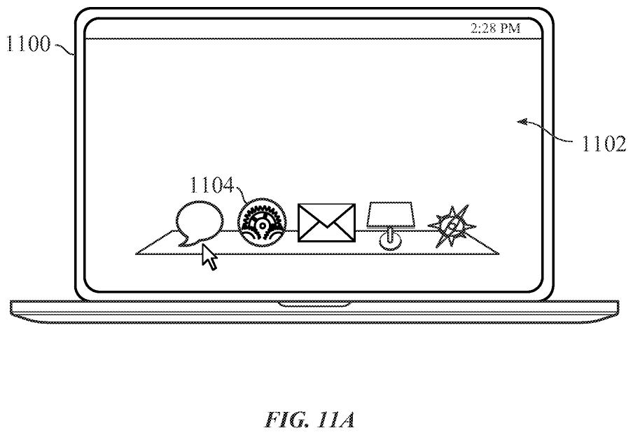

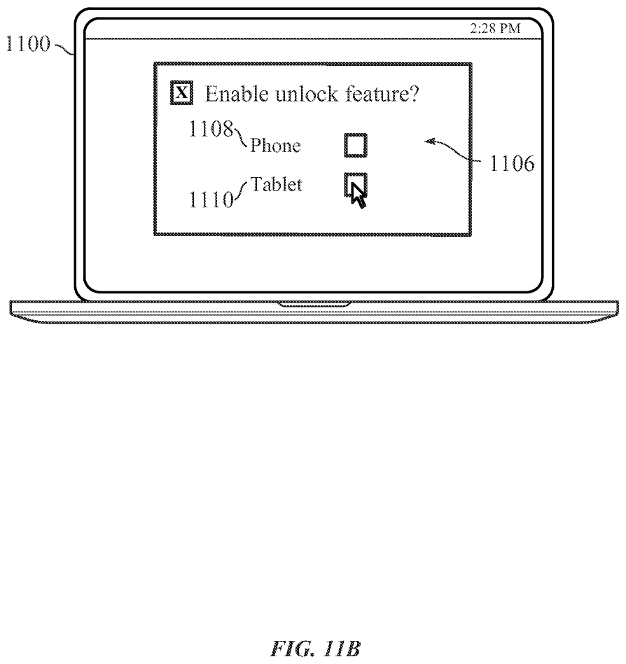

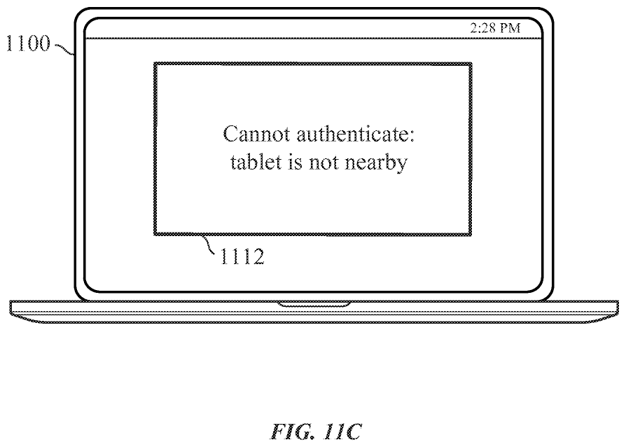

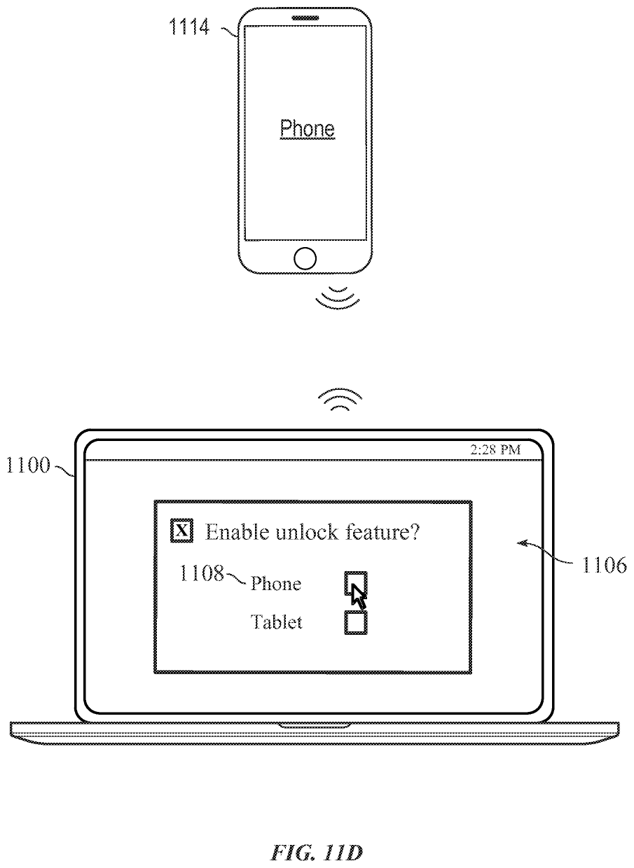

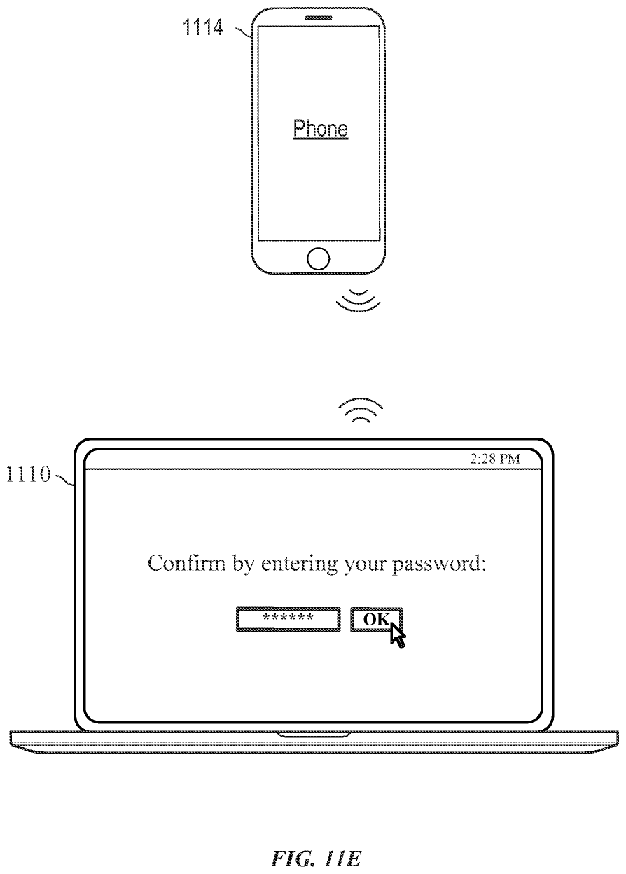

In some embodiments, a device may provide access to configuration settings that control whether certain external devices should be authenticated for purposes of auto-unlock features. This aspect is described with reference to FIGS. 11A-11C. FIG. 11A depicts device 1100, which may be device 300 (FIG. 3A) in some embodiments. Device 1100 may be unlocked and displaying desktop screen 1102. Desktop screen 1102 may have graphical user interface affordances for launching applications and other features, such as icon 1104 for configuring device settings. Configurable settings may include settings that identify external electronic devices for facilitating automatic unlocking of device 1100.

As shown in FIG. 11B, device 1100 may display listing 1106 of external devices that may become authenticated devices for purposes of auto-unlocking device 1100. The devices appearing in listing 1106 may be determined through various techniques. In some embodiments, device 1100 may be associated with a user identifier (e.g., an account or an e-mail address), and device 1100 may populate listing 1106 to include other devices associated with the same user account. In some embodiments, device 1100 may be a trusted member of a security domain, and device 110 may populate listing 1106 with external devices are trusted members of the same security domain. In some embodiments, device 1100 may contact a security or authentication server to determine whether two electronic devices are associated with one another. For example, device 1100 may contact a server to retrieve a list of devices that are trusted to a particular domain and/or registered to a given user identifier. In some embodiments, device 1100 may populate listing 1106 based on the physical proximity of external devices. For example, listing 1106 may list only those devices that are currently within wireless communication distance via a low-powered wireless communication protocol.

Listing 1106 may have checkboxes next to external devices that are listed. The checkboxes may specify whether the corresponding external devices should become authenticated for purposes of facilitating the auto-unlocking of device 1100. In the illustrated example, device 1100 displays listing 1106 with checkboxes 1108 and 1110 corresponding a “phone” and a “tablet” device. The “phone” and “tablet” devices, and device 1100, may each be associated with the same user identifier on a cloud-based service, such as iCloud® by Apple Inc. of Cupertino, CA.

FIG. 11C illustrates a possible response, of device 1100, to a user's selection of checkbox 1110. In the illustrated example, device 1100 requires a particular external device to be within communications range of device 1110 at the time of authentication for purposes of auto-unlocking functionality. In the illustrated example, the user's tablet computer lies outside of communications range with device 1100. Device 1110 thus displays message 1112 indicating that the tablet cannot be authenticated for purposes of auto-unlocking functionality.

FIGS. 11D-11E illustrates a possible response, by device 1100, to a user's selection of checkbox 1108. Checkbox 1108 represents the user's phone 1114, which is within communications range of device 1100 in the illustrated example. In this instance, device 1100 may register phone 1114 as an authenticated device, meaning that phone 1114 becomes authorized to unlock device 1100 if, in the future, phone 1114 appears within wireless communication range of device 1100, and phone 1114 is unlocked. Turning to FIG. 11E, device 1100 may further require the user to confirm the authentication of phone 1114 by entering the password for unlocking device 1100, on device 1100.

FIG. 12 is a flow diagram illustrating process 1200 for unlocking an electronic device using an authenticated external device. Process 1200 may be carried out by electronic devices such as devices 100, 300, and/or 500 (FIGS. 1A, 3A, 5A) in various embodiments. At block 1202, the electronic device, which is locked, detects an external device via wireless communication. The electronic device may verify that the detected external device is authenticated for purposes of auto-unlocking functionality. At block 1204, the electronic device receives, from the external device, unlocking information for unlocking the electronic device. The electronic device may confirm that the received information is valid and authentic. At block 1206, the electronic device detects, while in the locked state, user input. At block 1208, responsive to the received information and the detected user input, the device may unlock into its normal operating state. For example, in the unlocked state, the electronic device may permit a user to launch an application. Optionally, at block 1210, the electronic device may launch an application upon unlocking. The application that is launched may be the same application that is active on the external device. Optionally, when launched, the application may enter the same application state as the application that is active on the external device. That is, for example, the newly launched application, on the electronic device, may obtain and display the same web page or e-mail that is being displayed on the external device.

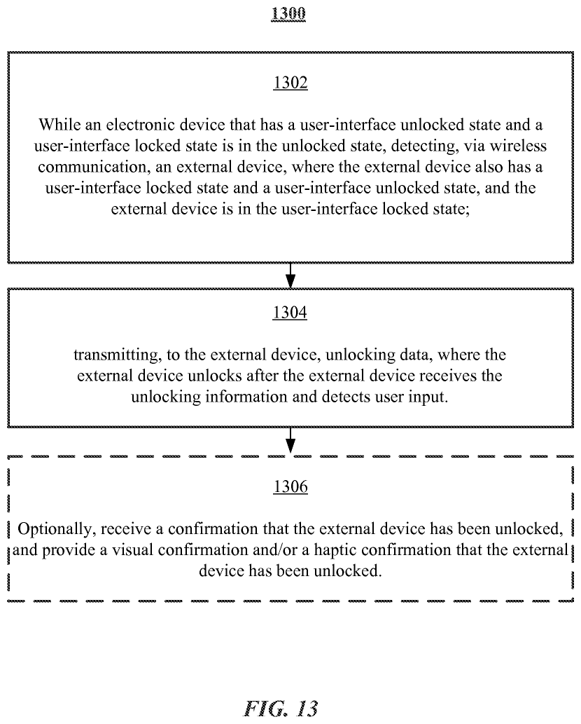

FIG. 13 is a flow diagram illustrating process 1300 for using an electronic device to unlock an external electronic device. Process 1300 may be carried out by electronic devices such as devices 100, 300, and/or 500 (FIGS. 1A, 3A, 5A) in various embodiments. The electronic device, which has a user-interface locked state and a user-interface unlock state, may be in the user-interface unlocked state. At block 1302, the electronic device may detect, via wireless communication, the external device. The external device also has a user-interface locked state and a user-interface unlocked state, and is in the user-interface locked state. At block 1304, the electronic device may transmit, to the external device, unlocking data, thereby causing the external device to unlock after the external device receives the unlocking information and detects user input. Optionally, at block 1306, the electronic device may provide a visual confirmation and/or a haptic confirmation that the external device has been unlocked. The confirmation may be provided after the electronic device obtains a confirmation that the external device has been unlocked.

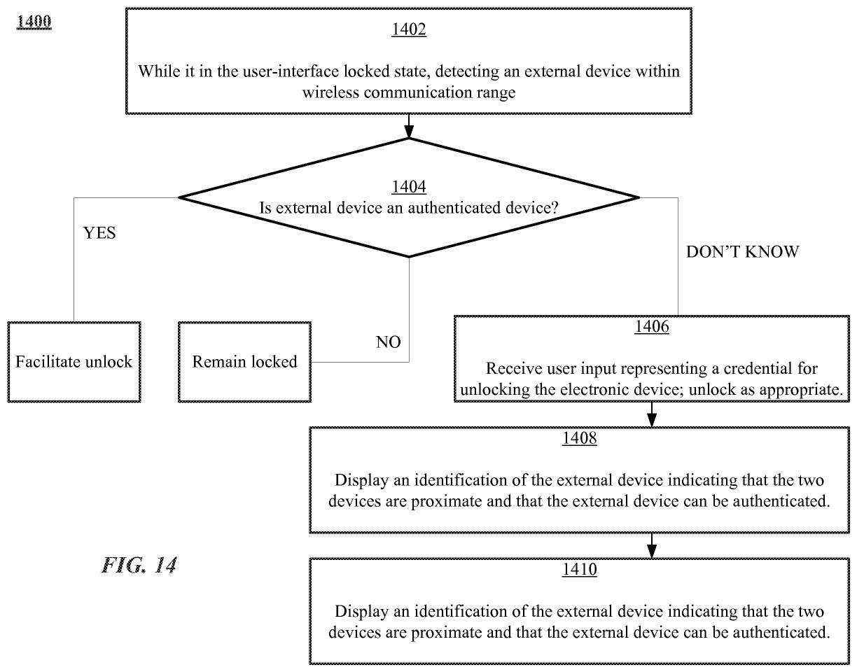

FIG. 14 is a flow diagram illustrating process 1400 for configuring an electronic device to recognize an external device as an authenticated external device for purposes of auto-unlocking functionality. Process 1400 may be carried out by electronic devices such as devices 100, 300, and/or 500 (FIGS. 1A, 3A, 5A) in various embodiments. At block 1402, the electronic device, which has a user-interface locked state and a user-interface unlocked state, may detect within its wireless communication range an external device. At block 1404, the electronic device may determine whether the external device has been previously authenticated for purposes of auto-unlocking the electronic device.

If the external device is an authenticated device for purposes of auto-unlocking the electronic device, the electronic device may proceed to auto-unlock, through the above-discussed user interfaces illustrated in FIGS. 5-7 and through process 1200 (FIG. 12), for example. If the external device has been previously registered as a non-authenticated device for purposes of auto-unlock functionality, the electronic device may remain locked and await other potential attempts at unlocking (such as the manual entry of a password).

If the external device has not yet been registered as either authenticated or non-authenticated, processing may proceed to block 1406, where the electronic device (which is locked), may receive user input representing a credential for unlocking the electronic device. In addition, the electronic device may verify the received credentials and unlock as appropriate. At block 1408, after unlocking, the electronic device may display an identification of the external device indicating that the two devices are physically proximate (e.g., within wireless communication range of a low powered communication protocol) and that the external device may become authenticated for purposes of auto-unlocking functionality. At block 1410, the electronic device may prompt the user to designate whether the external device should become authorized to unlock the electronic device if, in the future, the external device comes within wireless communication range of the electronic device while the electronic device is in the user-interface locked state.

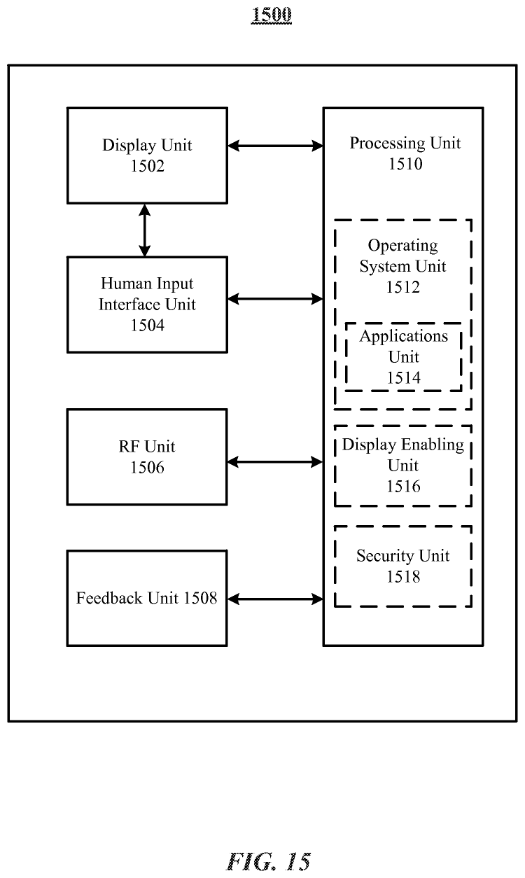

FIG. 15 shows exemplary functional blocks of an electronic device 1500 that, in some embodiments, performs the above-described features. As shown in FIG. 15, an electronic device 1500 may include display unit 1502 configured to display graphical objects; human input interface unit 1504 configured to receive user input; one or more RF units 1506 configured to detect and communicate with external electronic devices; one or more feedback unit configured to provide user with haptic, audio, and/or visual feedback; and processing unit 1510 coupled to display unit 1502, human input interface unit 1504, RF unit(s) 1506, and feedback unit 1508. In some embodiments, processing unit 1510 is configured to support an operating system running on operating system unit 1512. In turn, operating system unit 1512 may support an applications unit 1514 for launching and running one or more applications.

In some embodiments, the processing unit 1510 includes a display enabling unit 1516 and a security unit 1518. In some embodiments, the display enabling unit 1516 is configured to cause a display of a user interface (or portions of a user interface) in conjunction with the display unit 1502. For example, the display enabling unit 1516 may be used for: displaying a lock screen, displaying an unlocked screen, displaying a menu of application icons; displaying a desktop screen; displaying a prompt that prompts the user to specify whether an external device should become authenticated for purposes of auto-unlocking features.

In some embodiments, RF unit 1506 is configured to detect and receive information from an external device, such as credential information for facilitate the unlocking of the receiving device, application information, application state information, so forth. In some embodiments, the RF unit is configured to detect and transmit information to an external device, such as credential information for facilitating the unlocking of the receiving device, application information, application state information, so forth.

In some embodiments, the security unit 1518 is configured to receive input, e.g., through the use of human input interface unit 1504 and/or RF unit 1506. For example, security unit 1518 may determine whether information received from RF unit 1506 represents an authenticated device that can be used to facilitate unlocking. Security unit 1518 may also determine whether information received from human input interface unit 1504 is a set of valid credentials for unlocking electronic device 1500. Security unit 1518 may determine whether to unlock device 1500 based on received information from human input interface unit 1504 and/or RF unit 1506. Security unit 1518 may also cause the other units of device 1500 to prompt the user as to whether an external device should become authenticated for purposes of auto-unlocking functionality. Security unit 1518 may register authenticated devices so that device 1500 may recognize authenticated devices.

The units of FIG. 15 may be used to implement the various techniques and methods described above with respect to FIGS. 6-14. The units of device 1500 are, optionally, implemented by hardware, software, or a combination of hardware and software to carry out the principles of the various described examples. It is understood by persons of skill in the art that the functional blocks described in FIG. 15 are, optionally, combined or separated into sub-blocks to implement the principles of the various described examples. Therefore, the description herein optionally supports any possible combination or separation or further definition of the functional blocks described herein.

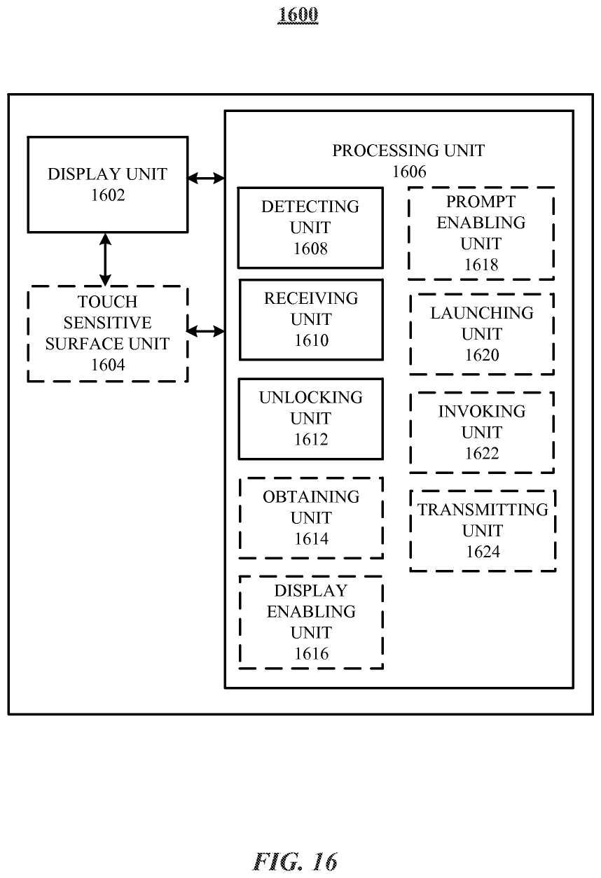

In accordance with some embodiments, FIG. 16 shows a functional block diagram of an electronic device 1600 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 16 are, optionally, combined or separated into sub-blocks to implement the principles of the various described embodiments. Therefore, the description herein optionally supports any possible combination or separation or further definition of the functional blocks described herein.

As shown in FIG. 16, an electronic device 1600 includes a display unit 1602 configured to display a graphic user interface, optionally, a touch sensitive surface unit 1604 configured to receive contacts, and a processing unit 1606 coupled to the display unit 1602 and, optionally, the touch-sensitive surface unit 1604. In some embodiments, the processing unit 1606 includes a detecting unit 1608, a receiving unit 1610, an unlocking unit 1612, an obtaining unit 1614, a display enabling unit 1616, a prompt enabling unit 1618, a launching unit 1620, an invoking unit 1622, and a transmitting unit 1624. The electronic device 1600, optionally, has a user-interface locked state and a user-interface unlocked state.

The processing unit 1606 is configured to detect (e.g., with the detecting unit 1608), via wireless communication, an external device; receive (e.g., with the receiving unit 1610), from the external device, unlocking information for unlocking the electronic device; detect (e.g., with the detecting unit 1608), while in the locked state, user input; and in response to detecting the user input and the received unlocking information, unlock (e.g., with the unlocking unit 1612) the electronic device.

In some embodiments, the external device has a user-interface locked state and a user-interface unlock state, the processing unit 1606 further configured to obtain (e.g., with the obtaining unit 1614) an indication that the external device is in the user-interface unlocked state, and unlock (e.g., with the unlocking unit 1612) the electronic device in response to the received unlocking information and the received user input, if the external device is in the user-interface unlocked state.

In some embodiments, the processing unit 1606 is further configured to enable display (e.g., with the display enabling unit 1616) of a visual indication on the electronic device indicating that it is in the user-interface unlocked state, after unlocking the electronic device.

In some embodiments, the external device displays a visual indication indicating that the electronic device is in the user-interface unlocked state, after the electronic device unlocks

In some embodiments, the external device causes a haptic event indicating that the electronic device is in the user-interface unlocked state, after the electronic device unlocks.

In some embodiments, the processing unit 1606 is further configured to receive (e.g., with the receiving unit 1610), while in the user-interface locked state, input data representing user input of a password; and in response to receiving the input data: enable prompting (e.g., with the prompt enabling unit 1618) of, on a display of the electronic device, a user to designate whether the external device is authorized to unlock the electronic device.

In some embodiments, the input data comprising a reading from a biometric sensor of the electronic device and/or a biometric sensor of the external device.

In some embodiments, the input data comprising a touch on a touch-sensitive input of the electronic device.

In some embodiments, the input data comprising movement of a mouse coupled to the electronic device and/or a mouse coupled to the external device.

In some embodiments, the user input comprising a keystroke on a keyboard of the electronic device.

In some embodiments, the processing unit 1606 is further configured to receive, from the external device, usage information indicating usage of the first application on the external device; and after unlocking, launch a second application on the electronic device, the second application corresponding to the first application.

In some embodiments, launching the second application comprises invoking the state in the second application on the electronic device.

In some embodiments, the detected user input is a user input on the electronic device.

In some embodiments, the unlocking information includes identification data based on an e-mail address associated with the electronic device, the processing unit 1606 further configured to unlock (e.g., with the unlocking unit 1612) the electronic device in response to the received unlocking information and the received user input, if the external device is associated with the e-mail address associated with the electronic device.

In some embodiments, the unlocking information includes identification data identifying the external device, the processing unit 1606 further configured to transmit (e.g., with the transmitting unit 1624), to an authentication server, at least a portion of the identification data; receive (e.g., with the receiving unit 1610), from the authentication server, an indication of whether the external device is authorized to unlock the electronic device; and unlock (e.g., with the unlocking unit 1612) the electronic device in response to the received unlocking information and the received user input, if the external device is authorized.

In some embodiments, the unlocking information includes identification of a security domain associated with the external device, the processing unit 1606 further configured to unlock (e.g., with the unlocking unit 1612) the electronic device in response to the received unlocking information and the received user input, if the electronic device is associated with the same security domain.

In some embodiments, the processing unit 1606 is further configured to detect (e.g., with the detecting unit 1608), via a peer-to-peer wireless communication, the external device.

In some embodiments, the wireless communication comprises Bluetooth communication.

In some embodiments, the external device is a wearable electronic device.

The operations described above with reference to FIG. 12 are, optionally, implemented by components depicted in FIGS. 1A-1B or FIG. 16. For example, detecting operations 1202 and 1206, receiving operation 1204, and unlocking operations 1208 and 1210 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

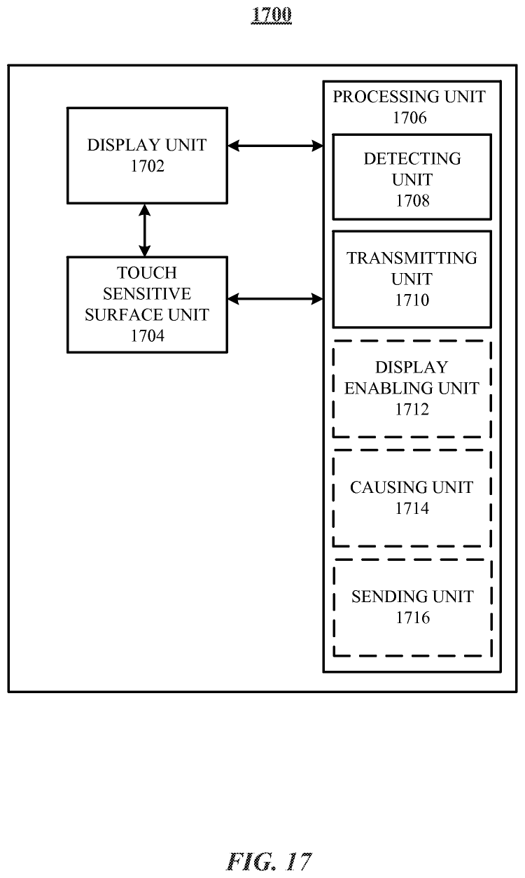

In accordance with some embodiments, FIG. 17 shows a functional block diagram of an electronic device 1700 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 17 are, optionally, combined or separated into sub-blocks to implement the principles of the various described embodiments. Therefore, the description herein optionally supports any possible combination or separation or further definition of the functional blocks described herein.

As shown in FIG. 17, an electronic device 1700 includes a display unit 1702 configured to display a graphic user interface, optionally, a touch sensitive surface unit 1704 configured to receive contacts, and a processing unit 1706 coupled to the display unit 1702 and, optionally, the touch-sensitive surface unit 1704. In some embodiments, the processing unit 1706 includes a detecting unit 1708, a transmitting unit 1710, a display enabling unit 1712, a causing unit 1714, and a sending unit 1716. The electronic device 1700, optionally, has a user-interface locked state and a user-interface unlocked state and may be in the user-interface unlocked state.

The processing unit 1706 is configured to detect (e.g., with the detecting unit 1708), via wireless communication, an external device, wherein the external device has a user-interface locked state and a user-interface unlocked state, and is in the user-interface locked state; and transmit (e.g., with the transmitting unit 1710), to the external device, unlocking data, where the external device unlocks after the external device receives the unlocking information and detects user input.

In some embodiments, the processing unit 1706 is further configured to enable display (e.g., with display enabling unit 1712) of a visual indication on the electronic device indicating that the external device is in the user-interface unlocked state, after the external device unlocks.

In some embodiments, the processing unit 1706 is further configured to cause (e.g., with the causing unit 1714) a haptic event on the electronic device indicating that the external device is in the user-interface unlocked state, after the external device unlocks.

In some embodiments, the external device displays a visual indication indicating that the external device is in the user-interface unlocked state, after the external device unlocks.

In some embodiments, the detected user input is a reading from a biometric sensor of the external device and/or a biometric sensor of the electronic device.

In some embodiments, the detected user input is a touch on a touch-sensitive input of the external device.

In some embodiments, the detected user input is movement of a mouse coupled to the external device and/or a mouse coupled to the electronic device.

In some embodiments, the detected user input is a keystroke on a keyboard of the external device.

In some embodiments, the detected user input is an input on the external device.

In some embodiments, the processing unit 1706 is executing a first application, the processing unit 1706 further configured to send (e.g., with the sending unit 1716), to the external device, usage information indicating usage of the first application on the electronic device, where the usage information at least in part causes the external device to display an affordance for unlocking and launching a second application on the external device, and where the second application corresponds to the first application.

In some embodiments, the usage information indicates a state of the first application, and wherein the state is invoked in the second application when the second application is launched on the external device.

In some embodiments, the electronic device is associated with an e-mail address, and the external device unlocks after confirming that the external device is associated with the same e-mail address as the e-mail address associated with the electronic device.

In some embodiments, an association of the electronic device and the external device is stored on an authentication server, and the external device unlocks after confirming, with the authentication server, the association.

In some embodiments, the electronic device is associated with a security domain, and the external device unlocks after confirming the external device is associated with the same security domain as the security domain associated with the electronic device.

In some embodiments, the processing unit 1706 is further configured to detect (e.g., with the detecting unit 1708), via a peer-to-peer wireless communication, the external device.

In some embodiments, the wireless communication comprises Bluetooth communication.

In some embodiments, the electronic device is a wearable electronic device.

The operations described above with reference to FIG. 13 are, optionally, implemented by components depicted in FIGS. 1A-1B or FIG. 17. For example, detecting operation 1302, transmitting operation 1304, and receiving operation 1306 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

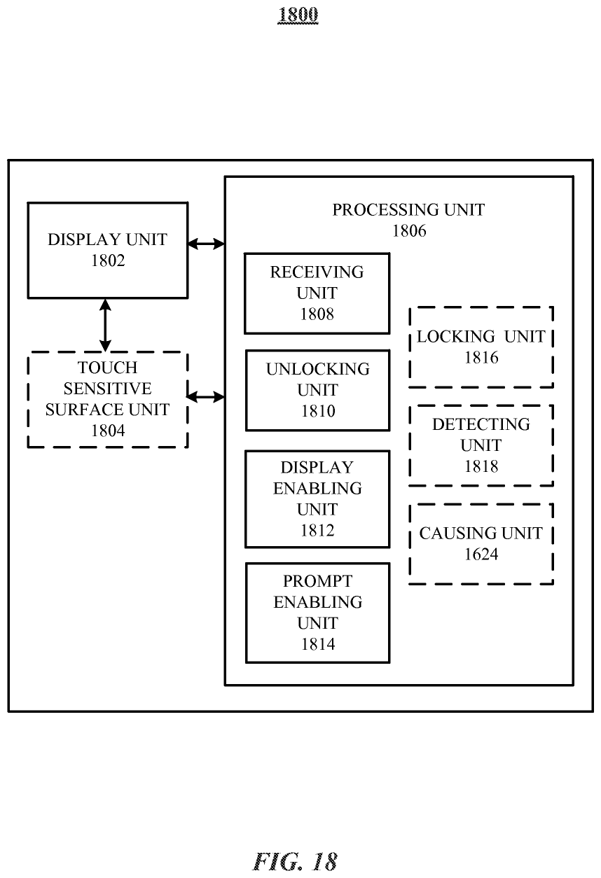

In accordance with some embodiments, FIG. 18 shows a functional block diagram of an electronic device 1800 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 18 are, optionally, combined or separated into sub-blocks to implement the principles of the various described embodiments. Therefore, the description herein optionally supports any possible combination or separation or further definition of the functional blocks described herein.

As shown in FIG. 18, an electronic device 1800 includes a display unit 1802 configured to display a graphic user interface, optionally, a touch sensitive surface unit 1804 configured to receive contacts, and a processing unit 1806 coupled to the display unit 1802 and, optionally, the touch-sensitive surface unit 1804. In some embodiments, the processing unit 1806 includes a receiving unit 1808, an unlocking unit 1810, a display enabling unit 1812, a prompt enabling unit 1814, a locking unit 1816, a detecting unit 1818, and a causing unit 1820. The electronic device 1800, optionally, has a user-interface locked state and a user-interface unlocked state and may be within wireless communication range of an external device.

The processing unit 1806 is configured to receive (e.g., with the receiving unit 1808), while in the user-interface locked state, user input representing a credential for unlocking the electronic device; in response to a determination that the credential is valid, unlock (e.g., with the unlocking unit 1810) the electronic device; after unlocking, enable display (e.g., with the display enabling unit 1812) of, on the display unit of the electronic device, an identification of the external device; and enable prompting (e.g., with the prompt enabling unit 1814) of a user to designate whether the external device is authorized to unlock the electronic device if, in the future, the external device comes within wireless communication range of the electronic device while the electronic device is in the user-interface locked state.

In some embodiments, the external device causes the electronic device to unlock if the external device is in the user-interface unlocked state when the external device comes within wireless communication with the electronic device.

In some embodiments, the user input is a first user input, the processing unit 1806 further configured to lock (e.g., with the locking unit 1816) the electronic device; detect (e.g., with the detecting unit 1818) second user input at the electronic device while the electronic device is in the user-interface locked state and the external device is within communications range; and in response to detecting the second user input, unlock (e.g., with the unlocking unit 1810) the electronic device.

In some embodiments, the processing unit 1806 is further configured to enable display (e.g., with the display enabling unit 1812) of a visual indication on the electronic device indicating that the electronic device is in the user-interface unlocked state, after the electronic device unlocks.

In some embodiments, the processing unit 1806 is further configured to enable display (e.g., with the display enabling unit 1812) of a visual indication on the external device indicating that the electronic device is in the user-interface unlocked state, after the electronic device unlocks.

In some embodiments, the processing unit 1806 is further configured to cause (e.g., with the causing unit 1820) a haptic event on the external device indicating that the electronic device is in the user-interface unlocked state, after the electronic device unlocks.

In some embodiments, receiving user input representing a credential for unlocking the electronic device comprises obtaining a reading from a biometric sensor of the electronic device.

In some embodiments, receiving user input representing a credential for unlocking the electronic device comprises detecting a touch on a touch-sensitive input of the electronic device.

In some embodiments, receiving user input representing a credential for unlocking the electronic device comprises detecting mouse movement of a mouse coupled to the electronic device.

In some embodiments, receiving user input representing a credential for unlocking the electronic device comprises detecting a keystroke on a keyboard of the electronic device.

In some embodiments, the processing unit 1806 is further configured to detect (e.g., with the detecting unit 1818), via a peer-to-peer wireless communication, the external device.

In some embodiments, the wireless communication comprises Bluetooth communication.

In some embodiments, the external device is a wearable electronic device.

The operations described above with reference to FIG. 14 are, optionally, implemented by components depicted in FIGS. 1A-1B or FIG. 18. For example, one or more operations described with reference to FIG. 14, including detecting operation 1402, determining operation 1404, receiving operation 1406, and displaying operations 1408 and 1410 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the appended claims.

What is claimed is:

1. An electronic device having a user-interface locked state and a user-interface unlocked state and is in the user-interface unlocked state, the electronic device comprising:
one or more processors;
a memory; and
one or more programs, wherein the one or more programs are stored in the memory and configured to be executed by the one or more processors, the one or more programs including instructions for:
detecting, via wireless communication, an external device, wherein the external device has a user-interface locked state and a user-interface unlocked state, and is in the user-interface locked state; and
transmitting, to the external device, unlocking data, wherein:
a user interface of the external device unlocks in response to detecting user input at the external device and receiving the unlocking data; and
the unlocking data is transmitted based on an indication that the electronic device is in the user-interface unlocked state.

2. The electronic device of claim 1, the one or more programs further including instructions for:
displaying a visual indication on the electronic device indicating that the external device is in the user-interface unlocked state, after the external device unlocks.

3. The electronic device of claim 1, the one or more programs further including instructions for:
causing a haptic event on the electronic device indicating that the external device is in the user-interface unlocked state, after the external device unlocks.

4. The electronic device of claim 1, wherein:
the external device displays a visual indication indicating that the external device is in the user-interface unlocked state, after the external device unlocks.

5. The electronic device of claim 1, wherein the detected user input is a reading from a biometric sensor of the external device and/or a biometric sensor of the electronic device.

6. The electronic device of claim 5, wherein the electronic device is unlocked based on the reading from the biometric sensor and a proximity of the external device to the electronic device.

7. The electronic device of claim 1, wherein the detected user input is a touch on a touch-sensitive input of the external device.

8. The electronic device of claim 1, wherein the detected user input is movement of a mouse coupled to the external device and/or a mouse coupled to the electronic device.

9. The electronic device of claim 1, wherein the detected user input is a keystroke on a keyboard of the external device.

10. The electronic device of claim 1, wherein the detected user input is an input on the external device.

11. The electronic device of claim 1, wherein the electronic device is executing a first application, the one or more programs further including instructions for:
sending, to the external device, usage information indicating usage of the first application on the electronic device,
wherein the usage information at least in part causes the external device to display an affordance for unlocking and launching a second application on the external device,
wherein the second application corresponds to the first application.

12. The electronic device of claim 11, wherein the usage information indicates a state of the first application, and wherein the state is invoked in the second application when the second application is launched on the external device.

13. The electronic device of claim 1, wherein
the electronic device is associated with an e-mail address, and
wherein the external device unlocks after confirming that the external device is associated with the same e-mail address as the e-mail address associated with the electronic device.

14. The electronic device of claim 1, wherein an association of the electronic device and the external device is stored on an authentication server, and wherein the external device unlocks after confirming, with the authentication server, the association.

15. The electronic device of claim 1, wherein
the electronic device is associated with a security domain, and
wherein the external device unlocks after confirming the external device is associated with the same security domain as the security domain associated with the electronic device.

16. The electronic device of claim 1, the one or more programs further including instructions for:
detecting, via a peer-to-peer wireless communication, the external device.

17. The electronic device of claim 1, wherein the wireless communication comprises Bluetooth communication.

18. The electronic device of claim 1, wherein the electronic device is a wearable electronic device.

19. A non-transitory computer readable storage medium storing one or more programs configured to be executed by one or more processors of an electronic device having a user-interface locked state and a user-interface unlocked state and is in the user-interface unlocked state, the one or more programs including instructions for:
detecting, via wireless communication, an external device, wherein the external device has a user-interface locked state and a user-interface unlocked state, and is in the user-interface locked state; and
transmitting, to the external device, unlocking data, wherein:
a user interface of the external device unlocks in response to detecting user input at the external device and receiving the unlocking data; and
the unlocking data is transmitted based on an indication that the electronic device is in the user-interface unlocked state.

20. A method, comprising:
at an electronic device, wherein the electronic device has a user-interface locked state and a user-interface unlocked state and is in the user-interface unlocked state:
detecting, via wireless communication, an external device, wherein the external device has a user-interface locked state and a user-interface unlocked state, and is in the user-interface locked state; and
transmitting, to the external device, unlocking data, wherein:
a user interface of the external device unlocks in response to detecting user input at the external device and receiving the unlocking data; and
the unlocking data is transmitted based on an indication that the electronic device is in the user-interface unlocked state.
